(19) United States
(12) Patent Application Publication
(10) Pub. No.: US 2025/0350564 A1
(43) Pub. Date: Nov. 13, 2025

(54) CONTROL APPARATUS, CONTROL METHOD, AND PROGRAM

(71) Applicant: NIPPON TELEGRAPH AND TELEPHONE CORPORATION, Tokyo (JP)

(72) Inventors: Kotaro ONO, Tokyo (JP); Kazuhiro TOKUNAGA, Tokyo (JP); Takehiro FUJINAGA, Tokyo (JP); Ryota ISHIBASHI, Tokyo (JP); Hiroaki MAEDA, Tokyo (JP); Takuya TOJYO, Tokyo (JP); Takeshi KUWAHARA, Tokyo (JP)

(21) Appl. No.: 18/870,763

(22) PCT Filed: May 12, 2023
(86) PCT No.: PCT/JP2023/017850

§ 371 Date: Dec. 2, 2024

(30) Foreign Application Priority Data
Jun. 14, 2022 (WO) PCT/JP2022/023862

(51) Int. Cl. H04L 47/25; H04L 43/08; H04L 47/24; H04W 28/08

(52) U.S. Cl. CPC H04L 47/25; H04L 43/08; H04L 47/24; H04W 28/0942

(57) ABSTRACT

A control apparatus includes a processor; and a memory storing instructions that cause the processor to execute a process. The process includes determining a network usage mode of a device on the basis of a prediction value of network quality for each communication priority and requirements related to transmission of information; and setting the network usage mode determined by the determining wherein the determining includes changing the network usage mode on the basis of a quality measurement result for each communication priority of a network used by the device.

### TECHNICAL FIELD

The present invention relates to a technique of controlling components involved in information transmission through a network in a system in which a terminal and an information processing infrastructure are connected to each other through a network.

### BACKGROUND ART

In recent years, edge/cloud computing has been utilized in various fields. In edge/cloud computing, terminal-side information that can be acquired by a sensor such as a camera or a light detection and ranging (LiDAR) is transmitted to an edge/cloud-side information processing infrastructure through a network, and information processing is performed for information users such as humans or AI. In addition, signals for controlling the terminal side are transmitted in a downlink direction from the information processing infrastructure side as necessary.

In smart agriculture and connected car-related fields, use cases such as remotely monitoring/controlling terminals on the basis of information that can be acquired on the terminal side are being examined, and techniques are being put into practical use for the purpose of securing safety of automated driving and creating dynamic maps.

Among a wide variety of sensor information, video has a wide range of applications for humans and AI, and is often focused on and handled as intuitively visible information. On the other hand, since video is a relatively large amount of information, related techniques are being examined in various fields for controlling video streaming from the aspect that ingenuity and a certain amount of cost are required to ensure real-time information transmission and its continuity.

### CITATION LIST

### Non Patent Literature

NPL 1: Video communication Smart-telecasterhttps://www.soliton.co.jp/products/category/product/video/smart_telecaster/?tab=02

### SUMMARY OF INVENTION

### Technical Problem

In order to realize remote monitoring control and automated driving in smart agriculture and connected car-related fields, it is necessary to continue real-time information transmission of a certain quality or higher. To realize this, using a conventional technique (NPL 1) of detecting a decrease in a network quality and performing follow-up control can be considered.

However, in the conventional technique of detecting a decrease in a network quality and performing follow-up control, there is a delay in follow-up due to an event-driven reactive response, and information transmitted during this delay time is not appropriately set/controlled, which can cause quality deterioration compared with the highest quality that can be acquired and bandwidth compression due to unexpected retransmission.

The present invention was contrived in view of the above points, and an object thereof is to provide a technique that makes it possible to proactively and reactively control an information transmission method.

### Solution to Problem

According to the disclosed technique, there is provided a control apparatus including:
a determination unit configured to determine a network usage mode of a device on the basis of a prediction value of network quality for each communication priority and requirements related to transmission of information; and
a setting unit configured to set the network usage mode determined by the determination unit in the device,
wherein the determination unit changes the network usage mode on the basis of a quality measurement result for each communication priority of a network used by the device.

### Advantageous Effects of Invention

According to the disclosed technique, it is possible to provide a technique that makes it possible to proactively and reactively control an information transmission method.

### BRIEF DESCRIPTION OF DRAWINGS

FIG. 1 is a diagram illustrating a system configuration example according to the present embodiment from a use case perspective.

FIG. 2 is a diagram illustrating an example of the overall configuration of a communication system.

FIG. 3 is a diagram illustrating configuration example 1 of a control apparatus 100.

FIG. 4 is a diagram illustrating configuration example 2 of the control apparatus 100.

FIG. 5 is a diagram illustrating function classification and the like in the control apparatus 100.

FIG. 6 is a diagram illustrating function classification and the like in the control apparatus 100.

FIG. 7 is a diagram illustrating an overview of control operation in the control apparatus 100.

FIG. 8 is a diagram illustrating an example of functional arrangement in the control apparatus 100.

FIG. 9 is a diagram illustrating an overview of control content in the control apparatus 100.

FIG. 10 is a sequence diagram in configuration example 1.

FIG. 11 is a sequence diagram in configuration example 2.

FIG. 12 is a flow of network usage mode determination and information setting determination.

FIG. 13 is a diagram illustrating an example of information transmission requirements and network quality-related information.

FIG. 14 is a diagram illustrating an example of information transmission requirements and information quality-related information.

FIG. 15 is a diagram illustrating Example 1.

FIG. 16 is a diagram illustrating Example 1.

FIG. 17 is a diagram illustrating Example 2.

FIG. 18 is a diagram illustrating Example 2.

FIG. 19 is a diagram illustrating Example 3.

FIG. 20 is a diagram illustrating Example 3.

FIG. 21 is a diagram illustrating Example 4.

FIG. 22 is a diagram illustrating Example 4.

FIG. 23 is a diagram illustrating Example 5.

FIG. 24 is a diagram illustrating Example 6.

FIG. 25 is a diagram illustrating Example 6.

FIG. 26 is a diagram illustrating Example 6.

FIG. 27 is a diagram illustrating Example 7.

FIG. 28 is a diagram illustrating Example 7.

FIG. 29 is a diagram illustrating Example 8.

FIG. 30 is a diagram illustrating Example 8.

FIG. 31 is a diagram illustrating Instance 11.

FIG. 32 is a diagram illustrating the efficiency of network usage resources in ascending order.

FIG. 33 is a diagram illustrating an example of information stored in a storage unit 150.

FIG. 34 is a diagram illustrating an example of network usage mode candidates.

FIG. 35 is a diagram illustrating an example of information stored in the storage unit 150.

FIG. 36 is a diagram illustrating an example of network usage mode candidates.

FIG. 37 is a diagram illustrating a hardware configuration example of the device.

### DESCRIPTION OF EMBODIMENTS

Hereinafter, an embodiment of the present invention (the present embodiment) will be described with reference to the accompanying drawings. An embodiment to be described below is an example, and an embodiment to which the present invention is applied is not limited to the following embodiment. Meanwhile, “/” used in the following description means “or.”. For example, “A/B” means “A or B”. However, “A/B” does not mean “only any one of A and B,” and “both A and B” is also included in the meaning of “A/B.”

In addition, for a specific communication scheme of a terminal in a multi-access network described in the present embodiment, any scheme may be used. For example, access traffic steering, switching and splitting (ATSSS) defined in 3GPP (registered trademark) may be used.

### Overview of Embodiment

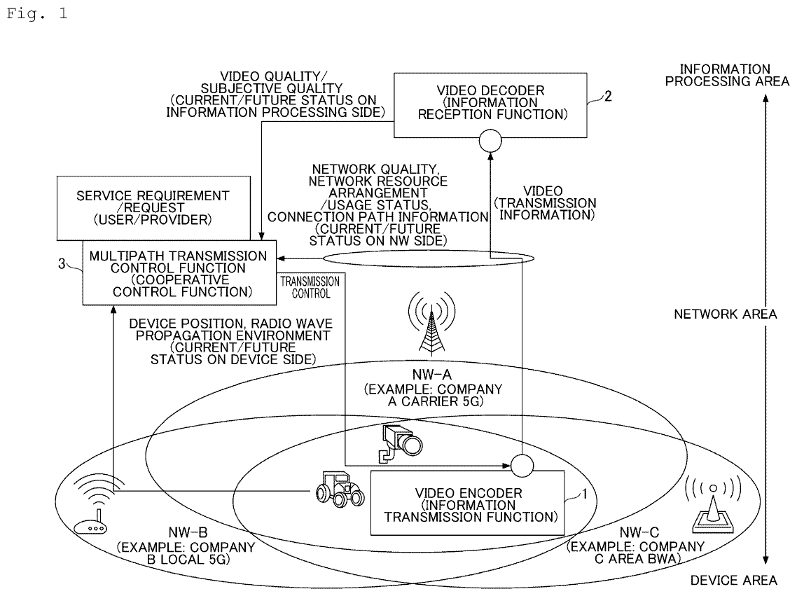

FIG. 1 shows a configuration example of a system according to the present embodiment in which a certain use case is assumed. The function names (device names) and information exchanged between devices (functions) shown in FIG. 1 are examples.

As shown in FIG. 1, this system is a system in a multi-access network environment where services are provided by multiple carriers (multi-carriers). In this environment, there are NW-A provided by Company A, NW-B provided by Company B, and NW-C provided by Company C.

In addition, specific examples to which this system is applied include remote monitoring control/automated driving of agricultural machinery such as tractors or combine harvesters, automated driving buses that provide unmanned shuttle services, and the like.

In this system, a video encoder (information transmission function) 1 transmits video (transmission information) to a video decoder (information reception function) 2. In addition, the video encoder (information transmission function) 1 transmits the device position/radio wave propagation environment (current/future status on the device side) to a multipath transmission control function (cooperative control function) 3.

In addition, the video decoder (information reception function) 2 transmits video quality/subjective quality (current/future status on the information processing side) to the multipath transmission control function (cooperative control function) 3. In addition, the multipath transmission control function (cooperative control function) 3 acquires a network quality, the arrangement/usage status of network resources, and connection path information (current/future status on the network side) from the network. In addition, the multipath transmission control function (cooperative control function) 3 receives service requirements/requests from users/providers. Meanwhile, the multipath transmission control function (cooperative control function) 3 is equivalent to a control apparatus 100 to be described later.

In such a system, in the present embodiment, the multipath transmission control function (cooperative control function) 3 controls an information transmission method in a multi-access network environment in real time to achieve both the fulfillment of requirements related to information transmission and the efficiency of a network resource usage.

In the above control, the multi-access network usage mode/multipath transmission is controlled. Examples of the control include the following control.
Selection of optimal network (single pass)
Connection path redundancy (multipath, redundancy mode)
Bandwidth expansion of narrow-band lines (multipath, bandwidth expansion mode)

In addition, the above control includes real-time control of an information generation method such as packet duplication and a transmission method such as allocation/grading.

The technique according to the present embodiment makes it possible to realize the continuation of real-time information transmission having a certain quality or higher, and to realize an improvement in resource utilization efficiency/reduction in cost by selectively using network resources in consideration of requirements related to information transmission. In addition, it is possible to realize flexible and real-time usage of a multi-access network that maximizes a range in which the requirement can be fulfilled.

The above function makes it possible to continue to fulfill the requirements, expand the range of targets, and reduce resource costs (efficient resource usage) for both users/providers of network resources.

### Related Art and Problems to be Solved

The technique disclosed in NPL 1 performs follow-up control based on detection of a decrease in a network quality in relation to “continuation of real-time information transmission of a certain quality or higher.”

However, in follow-up control based on detection of a decrease in a network quality, there is a delay in follow-up due to an event-driven/reactive response, and information transmitted during this delay time is not appropriately set/controlled, which can cause quality deterioration compared with the highest quality that can be acquired and bandwidth compression due to unexpected retransmission.

As a countermeasure to the above problem, proactive control based on the future prediction of network quality is assumed, but whether the transmission information is set/controlled appropriately depends on the accuracy of the future prediction of network quality, and quality deterioration compared with the highest quality that can be acquired and bandwidth compression due to unexpected retransmission can be caused as in the case of follow-up control when the accuracy is poor.

Hereinafter, a technique according to the present embodiment for solving the above problem will be described in detail. Hereinafter, a first embodiment and a second embodiment will be described.

### First Embodiment

### System Configuration Example

In the present embodiment, the above problem is solved by adopting a scheme of proactively and reactively controlling an information transmission method. That is, control based on an event-driven/reactive response is used in the related art, whereas proactive control based on future prediction is used in the present embodiment.

In addition, in the related art, deterioration in the quality of transmission information and bandwidth compression have occurred due to deterioration in the accuracy of future prediction, whereas in the present embodiment, high accuracy of reactive control based on analysis of the current situation based on past history and high accuracy of proactive control based on future prediction based on past/present analysis and a schedule/plan are realized.

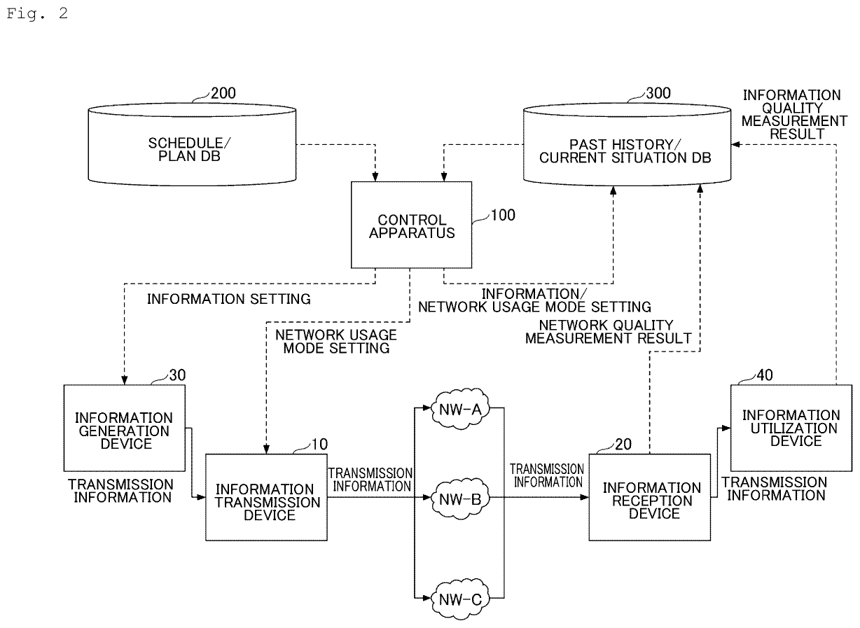

FIG. 2 shows an example of the overall configuration of a communication system in the present embodiment. As shown in FIG. 2, this communication system includes the control apparatus 100, a schedule/plan DB 200, and a past history/current situation DB 300. In addition, FIG. 2 shows an information transmission device 10, an information reception device 20, an information generation device 30, and an information utilization device 40 as devices serving as control targets/information collection sources.

The information transmission device 10 and the information reception device 20 can communicate with each other through any one or more of NW-A, NW-B, and NW-C. Meanwhile, devices to be controlled by the control apparatus 100 may be collectively referred to as a “device”. In addition, the information transmission device 10 and the information generation device 30 may be collectively referred to as a device.

The past history/current situation DB 300 stores information quality measurement results in the information utilization device 40, and stores network quality measurement results in the information reception device 20. In addition, an information/network usage mode is set in the past history/current situation DB 300.

The schedule/plan DB 200 stores information transmission requirements, an event/construction schedule in the surrounding environment on the device area side, a device operation plan, an information utilization schedule on the information processing area side, a use plan, and the like, and at least one of them is used by the control apparatus 100.

In addition, the past history/current situation DB 300 stores information collection results, device movement history, surrounding environmental conditions such as a radio wave propagation environment, network/information quality variation history, results of relationship/correlation evaluation between a device/network status and control results, and the like, and at least one of them is used by the control apparatus 100.

The control apparatus 100 uses the above information to set the network usage mode for the information transmission device 10. In addition, it is also possible to perform information setting on the information generation device 30. In addition, the control apparatus 100 stores setting content of information/network usage mode in the past history/current situation DB 300.

Meanwhile, the schedule/plan DB 200 and the past history/current situation DB 300 may be provided outside the control apparatus 100, or may be provided in a storage unit within the control apparatus 100. In an example to be described later, the schedule/plan DB 200 and the past history/current situation DB 300 are provided in a storage unit within the control apparatus 100.

### (Configuration Example of Control Apparatus 100)

### Configuration Example 1

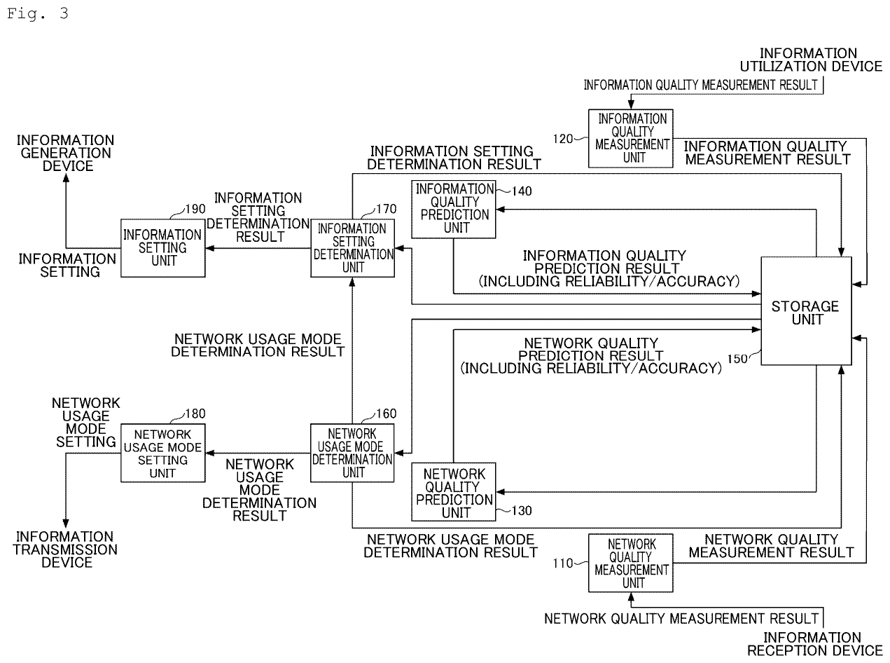

FIG. 3 shows configuration example 1 of the control apparatus 100. Configuration example 1 is a configuration example in a case where a final decision authority for the network usage mode is given to a network usage mode determination unit 160. Configuration example 1 is an example in a case where one network usage mode candidate is included in the network usage mode determination result.

As shown in FIG. 3, the control apparatus 100 includes a network quality measurement unit 110, an information quality measurement unit 120, a network quality prediction unit 130, an information quality prediction unit 140, a storage unit 150, the network usage mode determination unit 160, an information setting determination unit 170, a network usage mode setting unit 180, and an information setting unit 190. Meanwhile, the network quality measurement unit 110 and the information quality measurement unit 120 may be collectively referred to as a measurement unit. The network quality prediction unit 130 and the information quality prediction unit 140 may be collectively referred to as a prediction unit. The network usage mode determination unit 160 and the information setting determination unit 170 may be collectively referred to as a determination unit. The network usage mode setting unit 180 and the information setting unit 190 may be collectively referred to as a setting unit.

In addition, the control apparatus 100 may include a position acquisition unit (equivalent to a “time/position information acquisition/distribution function” to be described later).

The control apparatus 100 may be realized by one computer, or may be realized by a plurality of computers. The control apparatus 100 may be referred to as a control system. The operation of each unit is as follows.

The network quality measurement unit 110 acquires network quality measurement results from the information reception device 20 and stores the acquired network quality measurement results in the storage unit 150. The information quality measurement unit 120 acquires information quality measurement results from the information utilization device 40 and stores the acquired information quality measurement results in the storage unit 150.

The network quality prediction unit 130 acquires “the situation on the device area side, variation history of network quality, results of relationship/correlation evaluation between network quality prediction results based on the situation on the device side and measurement results, and the like” from the storage unit 150, predicts network quality on the basis of any one or more of these pieces of information, and stores the network quality prediction results in the storage unit 150.

The information quality prediction unit 140 acquires “the situation on the device/information processing area side, variation history of network/information quality, results of relationship/correlation evaluation between information quality prediction results based on the situation on the device/network area side and measurement results, and the like” from the storage unit 150, performs information quality prediction on the basis of any one or more of these pieces of information, and stores the information quality prediction results in the storage unit 150.

The network usage mode determination unit 160 acquires “information transmission requirements, the situation on the device area side, variation history of network quality, the network quality prediction results (including reliability/accuracy), results of relationship/correlation evaluation between network usage mode determination results based on the situation on the device/network area side and network/information quality measurement results, and the like” from the storage unit 150, performs network usage mode determination using any one or more of these pieces of information, stores the network usage mode determination result in the storage unit 150, and notifies the information setting determination unit 170 and the network usage mode setting unit 180 of the network usage mode determination result.

The information setting determination unit 170 acquires “information transmission requirements, the situation on the device/information processing area side, variation history of network/information quality, network/information quality prediction results (including reliability/accuracy), and results of relationship/correlation evaluation between information setting determination results based on the situation on the device/network area side and network usage mode determination results and information quality measurement results” from the storage unit 150, performs information setting determination using any one or more of these pieces of information, stores the information determination result in the storage unit 150, and notifies the information setting unit 190 of the result.

The network usage mode setting unit 180 receives the network usage mode determination result from the network usage mode determination unit 160 and set it in the information transmission device 10. The information setting unit 190 receives the information setting determination result from the information setting determination unit 170 and performs information setting in the information generation device 30 on the basis of the result.

From an implementation perspective, more specific examples will be described below. Meanwhile, the following specific examples are merely examples, and the technique according to the present invention is not limited to the following specific examples.

The information generation device 30 is, for example, a camera or an encoder. The information transmission device 10 is a network device (communication device) such as, for example, a router. The information generation device 30 and the information transmission device 10 may be one device.

The information reception device 20 and the network quality measurement unit 110 may be mounted as a network device such as a router. The information utilization device 40 and the information quality measurement unit 120 may be mounted with, for example, a display and a decoder. A human may perform the function of the information quality measurement unit 120.

The control apparatus 100 may be provided with a time/position information acquisition/distribution function such as a GNSS receiver or a PNSS client. The time/position information acquisition/distribution function acquires a terminal identifier (EID), acquires NMEA (including information on the current position of the terminal, current time, and the like) at a predetermined period (xHz), and stores these in the storage unit 150. In addition, the time/position information acquisition/distribution function acquires the position of the terminal in real time. The “time/position information acquisition/distribution function” may be referred to as a position acquisition unit. The position acquisition unit may be included in a measurement unit (for example, the network quality measurement unit 110). In addition, the position acquisition unit may be included in the terminal.

Meanwhile, the “terminal” (which may be referred to as a device) is, for example, the information transmission device 10 (or a device including the function of the information transmission device 10).

Information transmission requirements are stored in the storage unit 150 in advance. Examples of information transmission requirements include requirements related to video quality, requirements related to redundancy, and network-related requirements (such as usage priority).

The network quality measurement unit 110 acquires, for example, bandwidth, delay, and packet loss rate as network quality measurement results from the information reception device 20 (or the information transmission device 10, or both the information transmission device 10 and the information reception device 20).

The information quality measurement unit 120 acquires for example, MDI DF/MLR, frame rate, bit rate, and delay as information quality measurement results from the information utilization device 40 (or the information generation device 30, or both the information generation device 30 and the information utilization device 40). The occurrence status of video interruption may be monitored visually.

The network quality prediction unit 130 acquires a set of “terminal identifier (EID), NMEA, network quality prediction result, network usage mode, video transmission setting, and reception result” from the storage unit 150 before determination, and predicts the bandwidth, delay, and packet loss rate after t seconds at xHz on the basis of any one or more of these pieces of information.

The network usage mode determination unit 160 performs determination at a predetermined period, for example, in the following procedures of S1 to S4.

### S1)

Refer to a corresponding terminal identifier (EID) and the latest NMEA, and determine which are the device is in (image for dividing the location into squares) and which time division the current time belongs to (image of early morning, daytime, nighttime, midnight, etc.) are.

### S2)

Refer to the past history (a set of network usage mode, video transmission setting, and reception result) of a corresponding area, select the network usage mode with the best reception result and the minimum network usage among sets in which the reception result is OK. Definitions of terms will be described later.

### S3)

Refer to the quality prediction results of the networks included in the selected network usage mode (example: NW-A and NW-B), confirm whether the quality of each network falls below a predetermined quality (example: bandwidth determined in advance, bit rate of video transmission setting set in the past in the selected network usage mode), return to S2 if so to select the next network usage mode, and repeat thereafter.

### S4)

Establish the network usage mode determination result (example: a network to be used/bonded, usage priority for each network, upper-limit bandwidth to be set). Meanwhile, “bonding” involves using a plurality of networks.

Examples of the above-described definitions of “reception result OK,” “best reception result,” and “minimum network usage mode” are as follows.
Reception result OK: any or all of frame rate, bit rate, and delay fulfill the requirements, and no video interruption occurs.
Best reception result: bit rate is maximum.
Minimum network usage mode: the upper-limit bandwidth setting value of the network with the smallest number of networks to be bonded and the lowest usage priority is minimum.

The network usage mode determination unit 160 notifies the information setting determination unit 170 of the network usage mode determination result and the history of S2 referenced as the basis thereof (video transmission setting at the time of the best reception result in the network usage mode determined as the determination result).

The information setting determination unit 170 stores, for example, codec, resolution, frame rate, bit rate, and delay in the storage unit 150 as the video transmission setting which is an information determination result, and notifies the information setting unit 190.

### Configuration Example 2

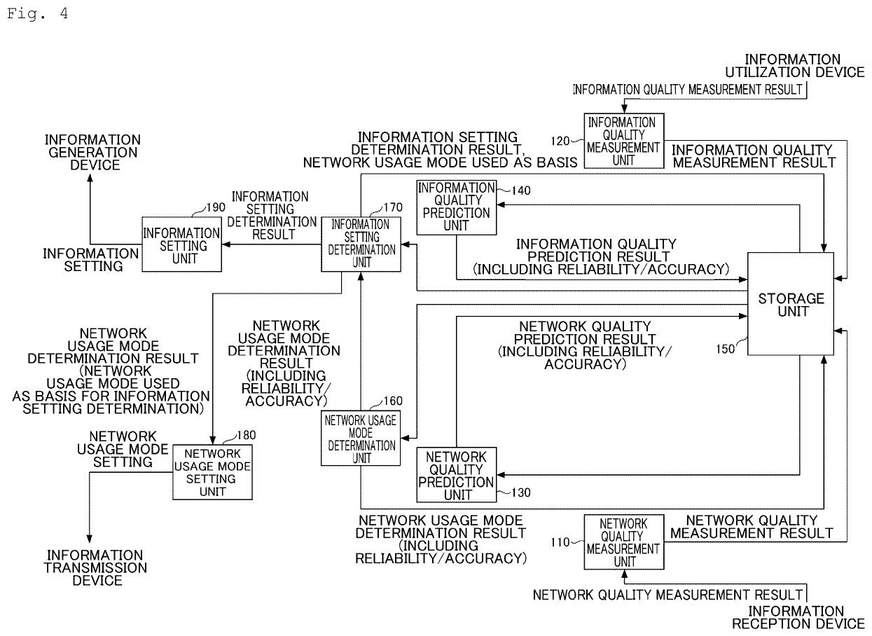

FIG. 4 shows configuration example 2 of the control apparatus 100. Configuration example 2 is a configuration example in a case where the final decision authority for the network usage mode is given to the information setting determination unit 170. Configuration example 2 is an example in a case where there are a plurality of network usage mode candidates included in the network usage mode determination result.

The functional units present in configuration example 1 of FIG. 3 and configuration example 2 of FIG. 4 are the same as each other. The main points that differ from configuration example 1 of FIG. 3 will be described.

In configuration example 2, the network usage mode determination unit 160 obtains network usage determination results including reliability/accuracy, and notifies the information setting determination unit 170 of the results. The information setting determination unit 170 determines the information setting, and notifies the network usage mode setting unit 180 of the network usage mode used as the basis for the information setting determination.

### <Examples of Function Classification and Mounting Functional Arrangement>

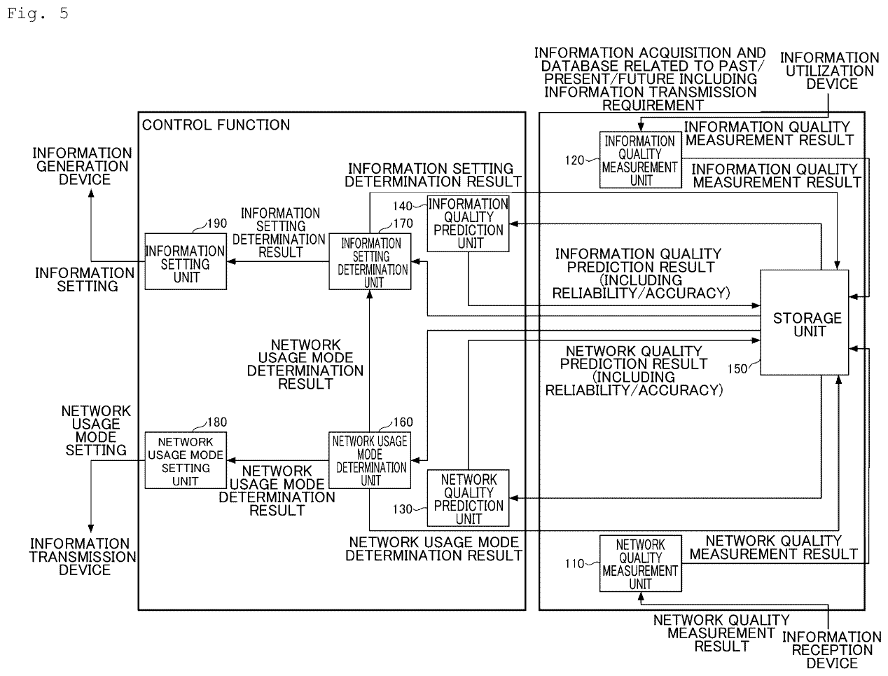

Hereinafter, function classification and the like will be described using configuration example 1 shown in FIG. 3 as an example. As shown in FIG. 5, the control apparatus 100 can be classified into control functions having “the network quality prediction unit 130, the information quality prediction unit 140, the network usage mode determination unit 160, the information setting determination unit 170, the network usage mode setting unit 180, and the information setting unit 190” and information acquisition and database functions related to the past/present/future including information transmission requirements having “the network quality measurement unit 110, the information quality measurement unit 120, and the storage unit 150.”

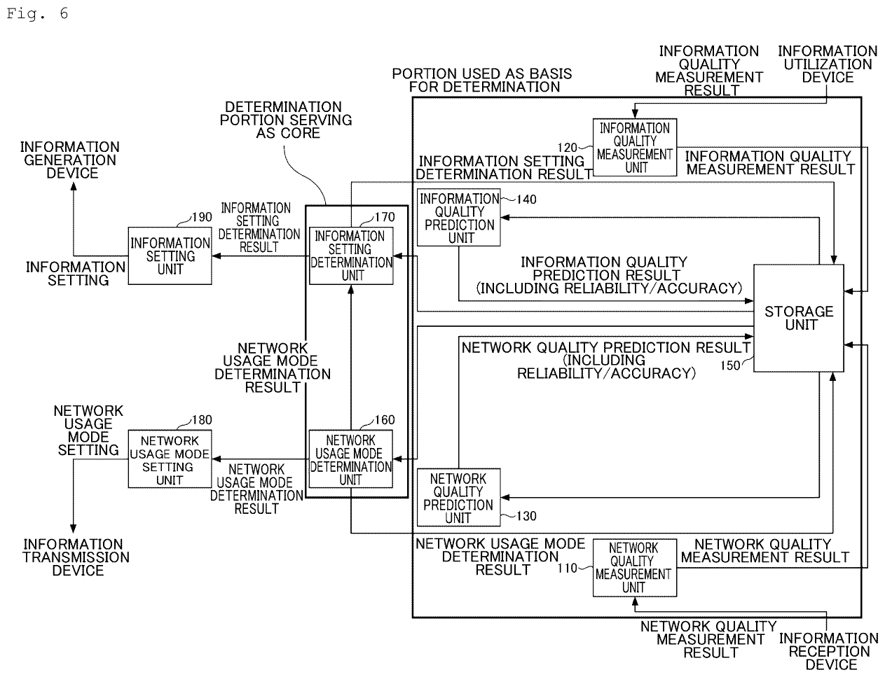

As shown in FIG. 6, the information setting determination unit 170 and the network usage mode setting unit 180 in the control apparatus 100 are portions serving as cores that perform determination, and “the network quality measurement unit 110, the information quality measurement unit 120, the network quality prediction unit 130, the information quality prediction unit 140, and the storage unit 150” are portions that provide information used as the basis for determination.

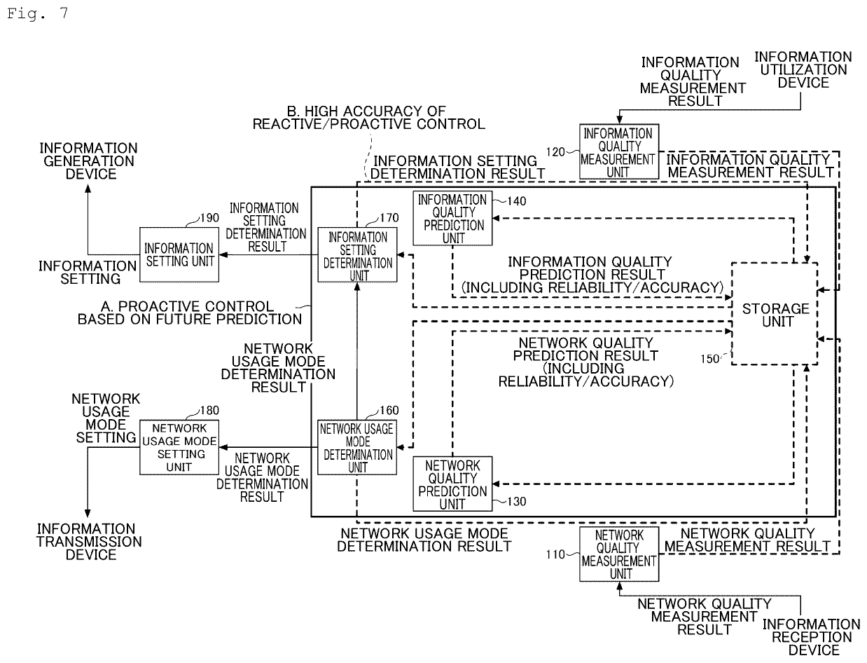

FIG. 7 shows an overview of control operation in the control apparatus 100. The control within the frame shown by the thick solid line indicates A. proactive control based on future prediction, and the flow shown by the thick dotted line indicates B. control for high accuracy of reactive/proactive control. That is, the control apparatus 100 achieves high accuracy by running a loop to determine what the device status is, what the network status is, what the determination result was, and based on that, how to determine the next device/network status.

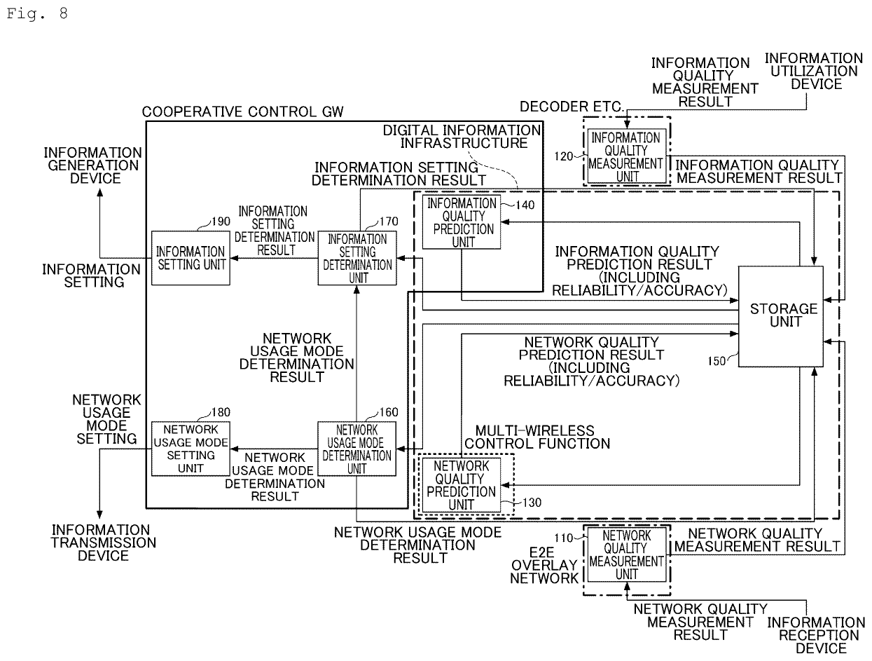

FIG. 8 shows an example of functional arrangement assumed in implementation. Here, this is just an example. In the example shown in FIG. 8, the portions of “the information quality prediction unit 140, the network usage mode determination unit 160, the information setting determination unit 170, the network usage mode setting unit 180, and the information setting unit 190” are implemented by a cooperative control GW (which may also be referred to as a control apparatus). The portions of “the network quality prediction unit 130, the information quality prediction unit 140, and the storage unit 150” are implemented by a digital information infrastructure. The digital information infrastructure as used herein is, for example, an infrastructure that integrates sensing data having high-accuracy position and time in real time on an “advanced geospatial information database” having high-accuracy and abundant semantic information, performs high-speed analysis processing and future prediction.

The network quality prediction unit 130 is implemented by a multi-radioproactive control technique, and the information quality measurement unit 120 is implemented by a technique of identifying and visualizing a communication flow in real time, a decoder, and the like. In addition, the network quality measurement unit 110 is implemented by, for example, an E2E overlay network.

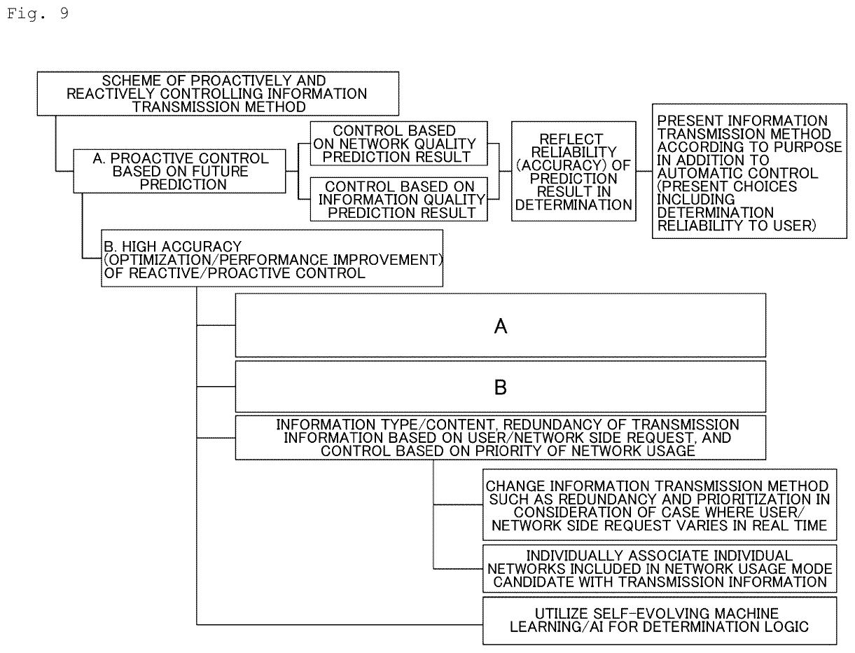

FIG. 9 is a diagram illustrating what kind of control a scheme of proactively and reactively controlling an information transmission method in the control apparatus 100 is constituted by. As shown in the drawing, it is broadly divided into proactive control based on future prediction and high accuracy (optimization/performance improvement) of reactive/proactive control, and each performs the control shown in FIG. 9.

The description of “A” in FIG. 9 is “information transmission requirements, the situation on the device/information processing area side, variation history of network/information quality, network/information quality prediction results (including reliability/accuracy), and results of relationship/correlation evaluation between information setting determination results based on the situation on the device/network area side and network usage mode determination results and information quality measurement results are reflected in the information setting determination.”

The description of “B” is “information transmission requirements, the situation on the device area side, variation history of network quality, the network quality prediction results (including reliability/accuracy), and results of relationship/correlation evaluation between network usage mode determination results based on the situation on the device/network area side and network/information quality measurement results are reflected in the network usage mode determination.”

### (Operating Sequence)

Next, the operating sequence in the control apparatus 100 will be described for each of configuration example 1 (FIG. 3) and configuration example 2 (FIG. 4).

### <Sequence in Configuration Example 1>

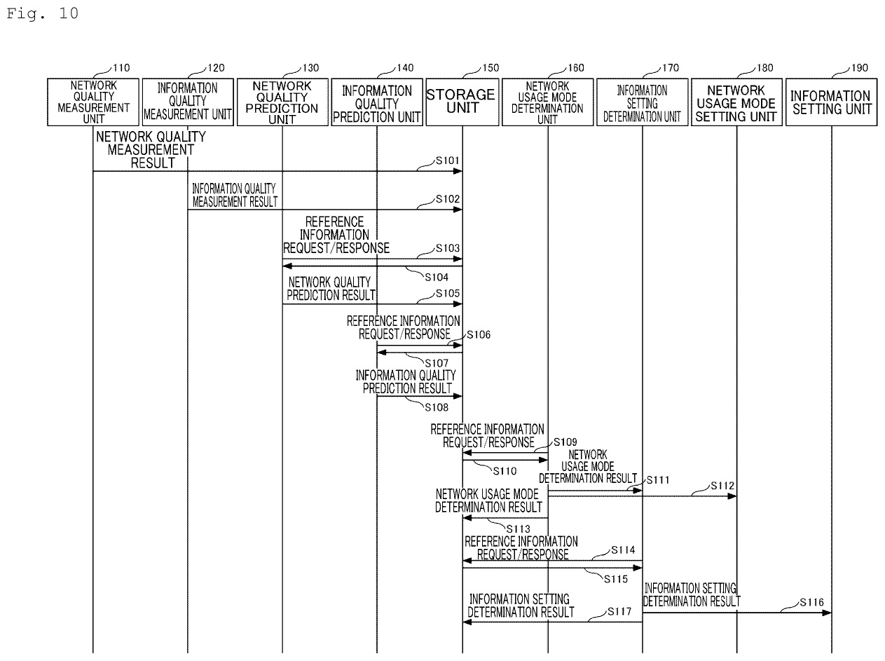

First, a sequence in configuration example 1 will be described with reference to FIG. 10. As described above, configuration example 1 is an aspect in which the final decision authority for the “network usage mode” is given to “the network usage mode determination unit 160.”

In S101, the network quality measurement unit 110 transmits the network quality measurement result to the storage unit 150, and the storage unit 150 stores the received network quality measurement result.

In S102, the information quality measurement unit 120 transmits the information quality measurement result to the storage unit 150, and the storage unit 150 stores the received information quality measurement result.

In S103 and S104, a reference information request/response is transmitted and received between the network quality prediction unit 130 and the storage unit 150.

In S105, the network quality prediction unit 130 predicts a network quality on the basis of information acquired from the storage unit 150 and transmits the network quality prediction result to the storage unit 150, and the storage unit 150 stores the received network quality prediction result.

In S106 and S107, the reference information request/response is transmitted and received between the information quality prediction unit 140 and the storage unit 150.

In S108, the information quality prediction unit 140 performs information quality prediction on the basis of the information acquired from the storage unit 150 and transmits the information quality prediction result to the storage unit 150, and the storage unit 150 stores the received information quality prediction result.

In S109 and S110, the reference information request/response is transmitted and received between the storage unit 150 and the network usage mode determination unit 160.

The network usage mode determination unit 160 performs the network usage mode determination on the basis of the information acquired from the storage unit 150, and transmits the network usage mode determination result to the information setting determination unit 170, the network usage mode setting unit 180, and the storage unit 150 in S111 to S113.

In S114 and S115, the reference information request/response is transmitted and received between the storage unit 150 and the information setting determination unit 170.

In S116 and S117, the information setting determination unit 170 performs the information setting determination on the basis of the information acquired from the storage unit 150, and transmits the information setting determination result to the information setting unit 190 and the storage unit 150.

### <Sequence in Configuration Example 2>

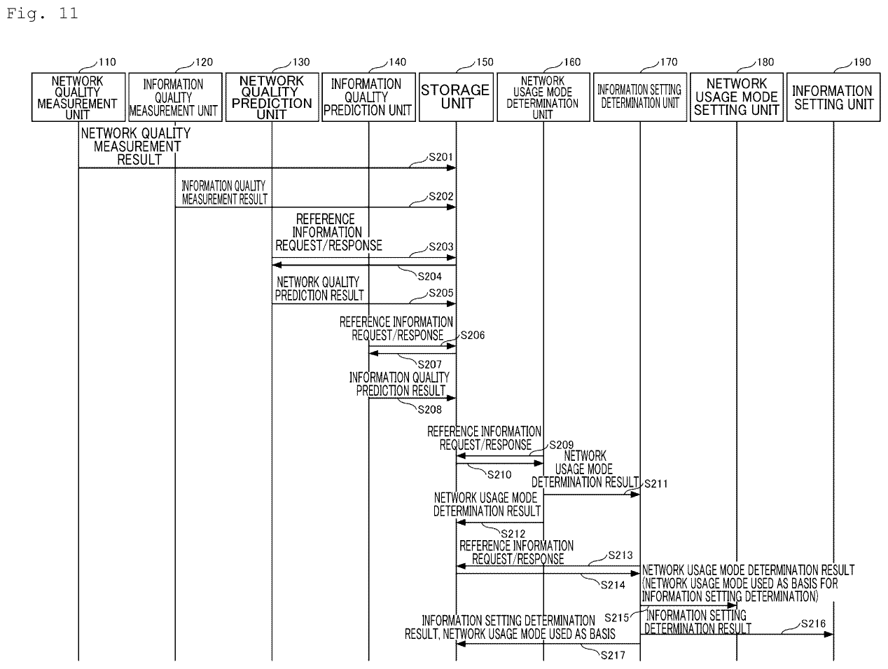

Next, a sequence in configuration example 2 will be described with reference to FIG. 11. As described above, configuration example 2 is an aspect in which the final decision authority for the “network usage mode” is given to “the information setting determination unit 170”. S201 to S208 in FIG. 11 are the same as S101 to S108 in FIG. 10. The processing after S208 will be described.

In S209 and S210, the reference information request/response is transmitted and received between the storage unit 150 and the network usage mode determination unit 160.

The network usage mode determination unit 160 performs the network usage mode determination on the basis of the information acquired from the storage unit 150, and transmits the network usage mode determination result to the information setting determination unit 170 and the storage unit 150 in S211 to S212.

In S213 and S214, reference information request/response is transmitted and received between the storage unit 150 and the information setting determination unit 170.

The information setting determination unit 170 performs the information setting determination on the basis of the information acquired from the storage unit 150. In S215, the information setting determination unit 170 transmits the network usage mode determination result (the network usage mode used as the basis for the information setting determination) to the network usage mode setting unit 180.

In S216 and S217, the information setting determination unit 170 transmits the information setting determination result to the information setting unit 190 and the storage unit 150. The network usage mode used as the basis is transmitted to the storage unit 150 together with the information setting determination result, and the storage unit 150 stores them.

In configuration example 2, the information setting determination unit 170 directly notifies the network usage mode setting unit 180 of the “final network usage mode determination result,” but this is just an example. The information setting determination unit 170 may notify the network usage mode determination unit 160 of the “final network usage mode determination result,” and the network usage mode determination unit 160 may notify the network usage mode setting unit 180 and the storage unit 150 of the “final network usage mode determination result.”

### (Flow Example of Network Usage Mode and Information Setting Determination)

A flow example for the network usage mode determination and the information setting determination will be described. Here, the “information” to be controlled is assumed to be video.

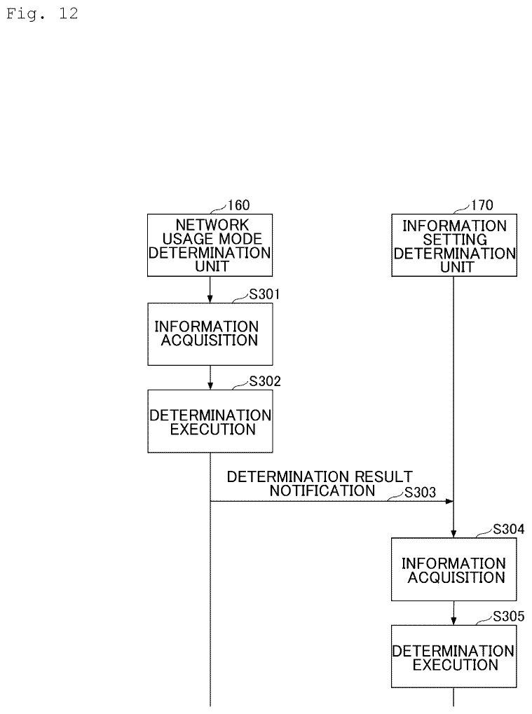

First, a flow will be described with reference to FIG. 12. In S301, the network usage mode determination unit 160 acquires information transmission requirements and network quality-related information from the storage unit 150. In S302, the network usage mode determination unit 160 performs the network usage mode determination on the basis of the information acquired in S301.

In S303, the network usage mode determination unit 160 notifies the information setting determination unit 170 of the network usage mode determination result.

In S304, the information setting determination unit 170 acquires information transmission requirements and information quality-related information from the storage unit 150. In S305, the information setting determination unit 170 performs the information setting determination on the basis of the information acquired in S304.

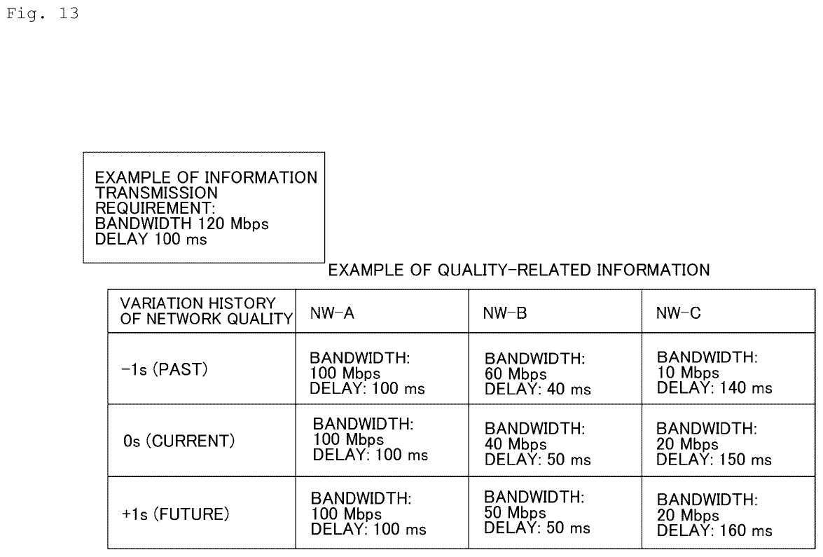

FIG. 13 shows an example of information transmission requirements and network quality-related information acquired in S301 by the network usage mode determination unit 160. Here, for example, it is assumed that which network is to be used in the future by the information transmission device 10 is a “network usage mode”. In the example of FIG. 13, since the information transmission requirements are a bandwidth of 120 Mbps and a delay of 100 ms, the network usage mode determination unit 160 determines that NW-A and NW-B will be used in the future +1 second later. In this case, the information setting determination unit 170 is notified of the information “NW-A and NW-B are used 1 second later.” Meanwhile, the network usage mode determination unit 160 may narrow down the network usage mode candidates on the basis of the information transmission requirements or user/network side request, or may determine the network usage mode after prioritizing individual networks.

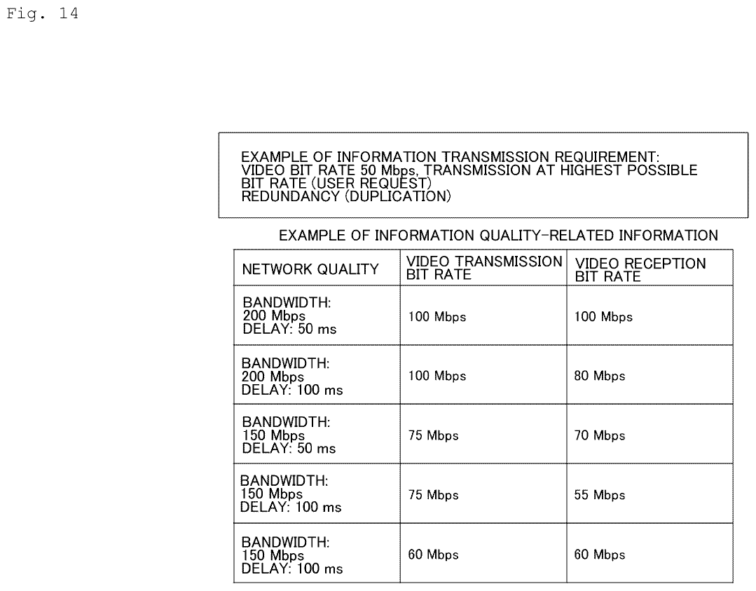

FIG. 14 shows an example of information transmission requirements and information quality-related information acquired in S304 by the information setting determination unit 170. Here, for example, information generation device 10 determines whether at which bit rate the video is to be encoded. In the example of FIG. 14, the information setting determination unit 170 determines, for example, that the video transmission bit rate is set to 60 Mbps. Meanwhile, the information setting determination unit 170 may perform the information setting determination in consideration of the request/policy on the network side while premising the information transmission requirements and the user request.

Hereinafter, specific examples of network usage mode determination/information setting determination will be described as Examples 1 to 8. Examples 1 to 8 can be implemented in any combination.

### Example 1

In Example 1, the network quality prediction unit 130 predicts a network quality for a certain device (example: the information transmission device 10) from the device position, received signal strength (example: reception strength on the transmission side), and network quality measurement result (example: quality measured on the reception side), and the network usage mode determination unit 160 determines the network usage mode on the basis of the prediction result. Meanwhile, the target for determination of the network usage mode being the information transmission device 10 is the same in the following examples as well.

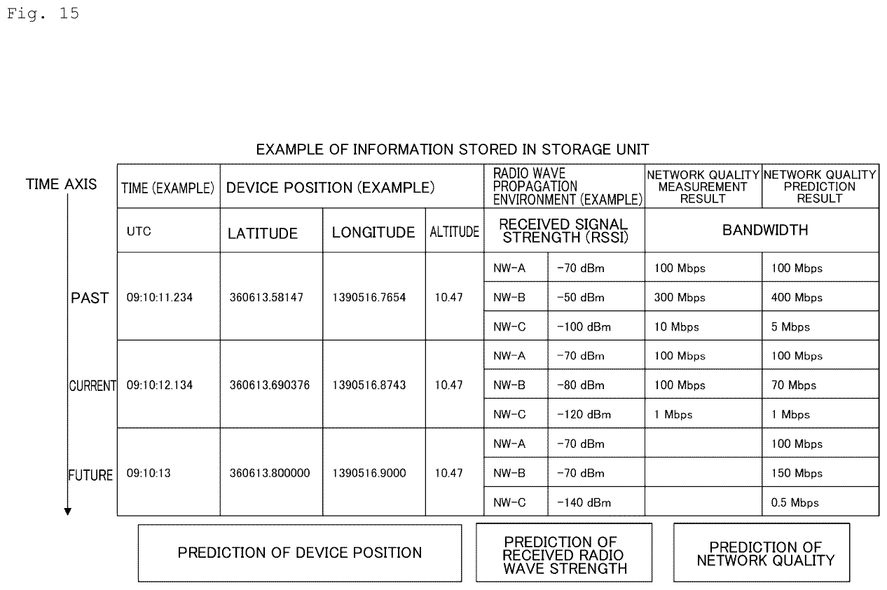

FIG. 15 shows an example of information stored in the storage unit 150 in Example 1. As shown in FIG. 15, the storage unit 150 stores values of past and current measurement results by the network quality measurement unit 110 and future prediction values by the network quality prediction unit 130 for the device position, received radio wave strength, and network quality.

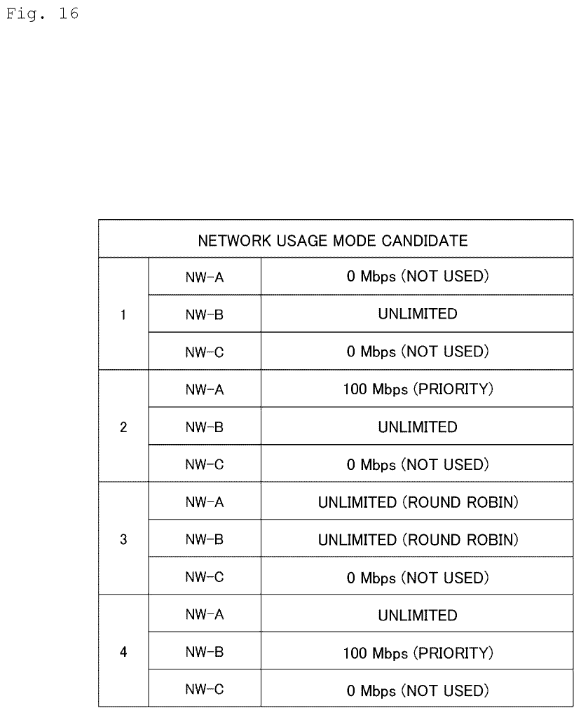

In Example 1, it is also assumed that “bandwidth requirement: 120 Mbps, user request: NW-A priority” is stored in the storage unit 150. FIG. 16 shows an example of network usage mode candidates determined on the basis of the prediction values shown in FIG. 15 and “bandwidth requirement: 120 Mbps, user request: NW-A priority.”

As shown in FIG. 16, a plurality of candidates are determined (decided) in consideration of the user request while satisfying the bandwidth requirements on the basis of the prediction value (NW-C is poor in quality or the like).

Meanwhile, there is no particular limitation on a method by which the prediction unit predicts a future value on the basis of the past and current values, and any method can be used. For example, it may be predicted using a regression analysis or may be predicted using a neural network model.

### Example 2

Next, Example 2 will be described. In Example 2, the network usage mode determination unit 160/the information setting determination unit 170 determines the network usage mode/information setting for a certain device (example: the information transmission device 10 and the information generation device 30) from the network quality measurement/prediction result by the network quality measurement unit 110/the network quality prediction unit 130 and the information quality measurement/prediction result by the information quality measurement unit 120/the information quality prediction unit 140.

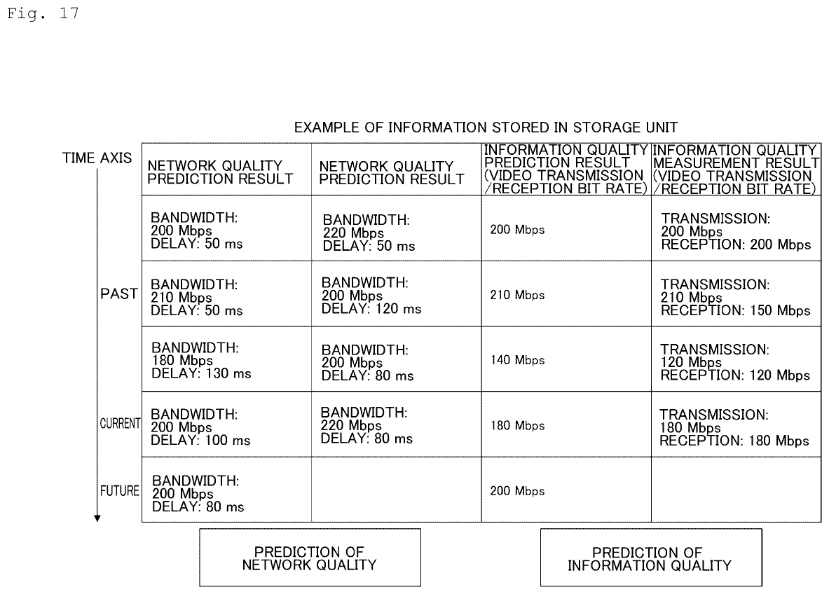

FIG. 17 shows an example of information stored in the storage unit 150 in Example 2. As shown in FIG. 17, the storage unit 150 stores the prediction result and measurement result for the network quality and information quality. Meanwhile, information of each network may be stored for the prediction result and measurement result shown in FIG. 17.

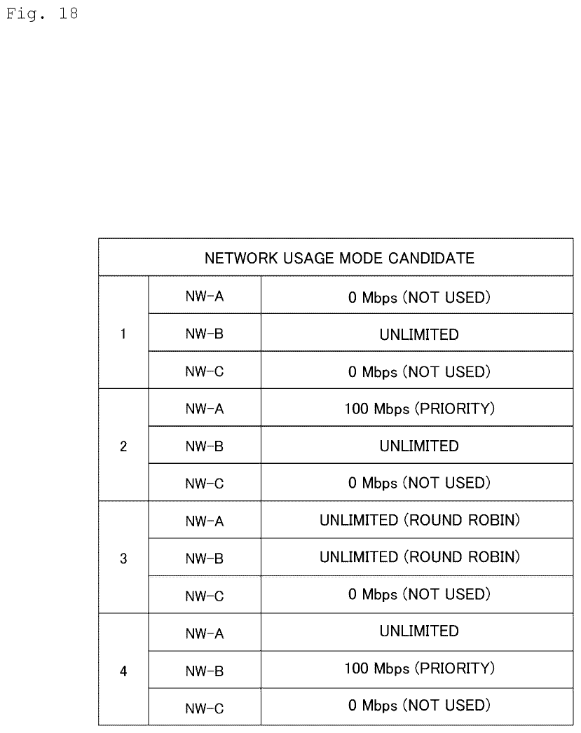

In Example 2, it is also assumed that “video quality requirement: 120 Mbps or higher, user request: NW-A priority” is stored in the storage unit 150. In this case, the information setting determination unit 170 determines, for example, the video transmission bit rate setting to be 180 Mbps. In addition, the network usage mode determination unit 160 decides, for example, the candidates shown in FIG. 18 as network usage mode candidates.

### Example 3

Next, Example 3 will be described. Example 3 is an example in which a determination logic is made highly accurate on the basis of information managed in the storage unit 150.

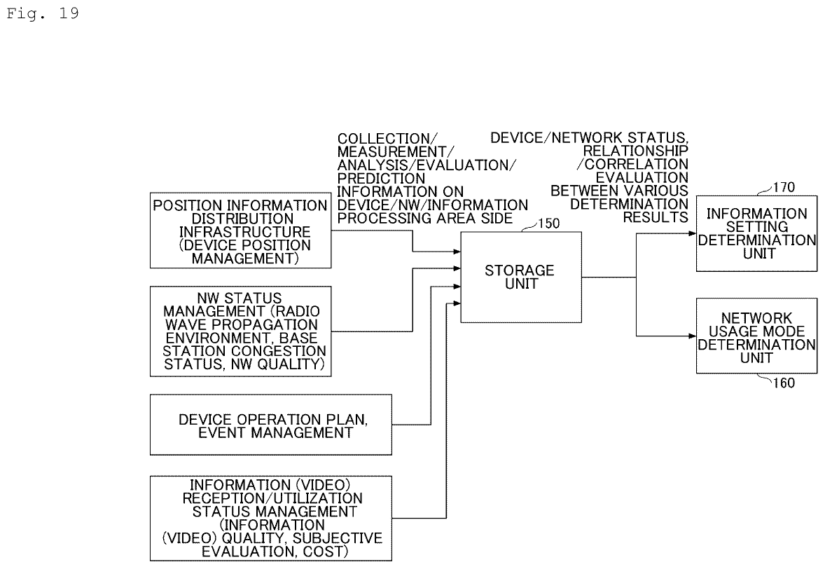

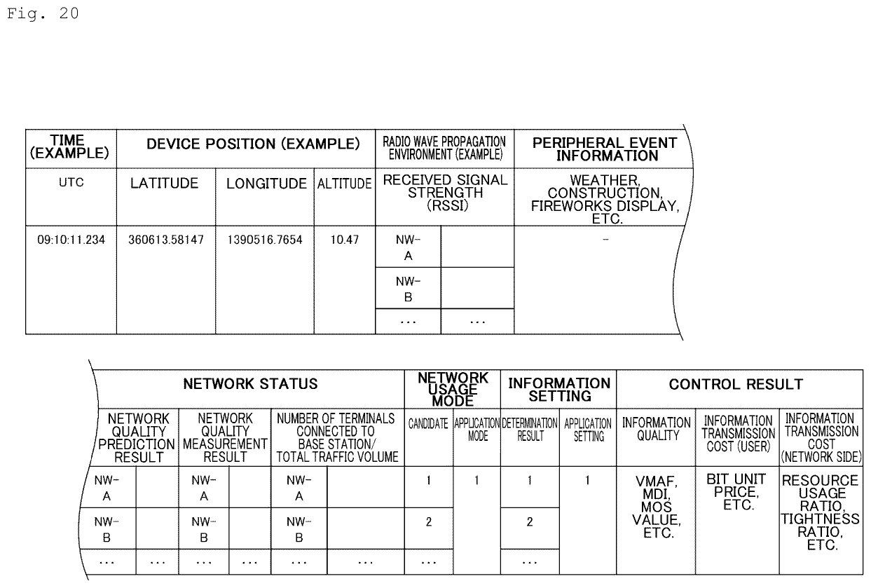

As shown in FIG. 19, in Example 3, the device position, radio wave propagation environment, base station congestion status, network quality, device operation plan, event information, information (video) quality, subjective evaluation, cost, and the like are stored in the storage unit 150. FIG. 20 shows an example of information stored in the storage unit 150.

As shown in FIG. 20, by adding peripheral event information (information on future schedules) or the like in the determination, the network usage mode determination unit 160/the information setting determination unit 170 can perform the determination with a good degree of accuracy. For example, in a case where the time at which a large-scale event affecting the traffic of the network is performed is known, it is possible to make a determination at that time that an operator used in the event avoids using the network.

The determination by the network usage mode determination unit 160/the information setting determination unit 170 can be made highly accurate by running a loop to determine what the device status is, what the network status is, what the determination result was, and based on that, how to determine the next device/network status while using detailed information as shown in FIG. 20.

### Example 4

Next, Example 4 will be described. In Example 4, an example in which the use of multi-access networks is implemented by lowering it to the usage “priority” for each network will be described.

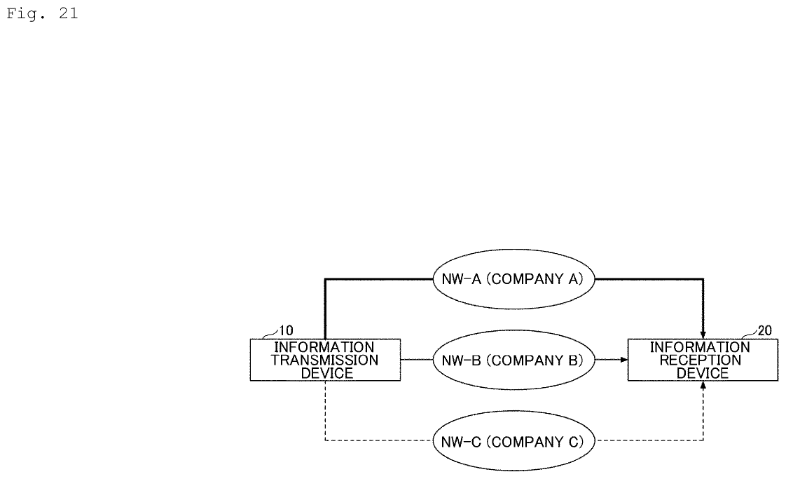

In Example 4, as shown in FIG. 21, there are NW-A (Company A), NW-B (Company B), and NW-C(Company C), and the information transmission device 10/the information reception device 20 can be connected to any of the networks. In addition, the information transmission device 10 and the information reception device 20 can also be connected two or three networks simultaneously. This point also applies to Examples 5 to 8. Meanwhile, Company A is assumed to be a communication carrier that operates the control apparatus 100 according to the present embodiment.

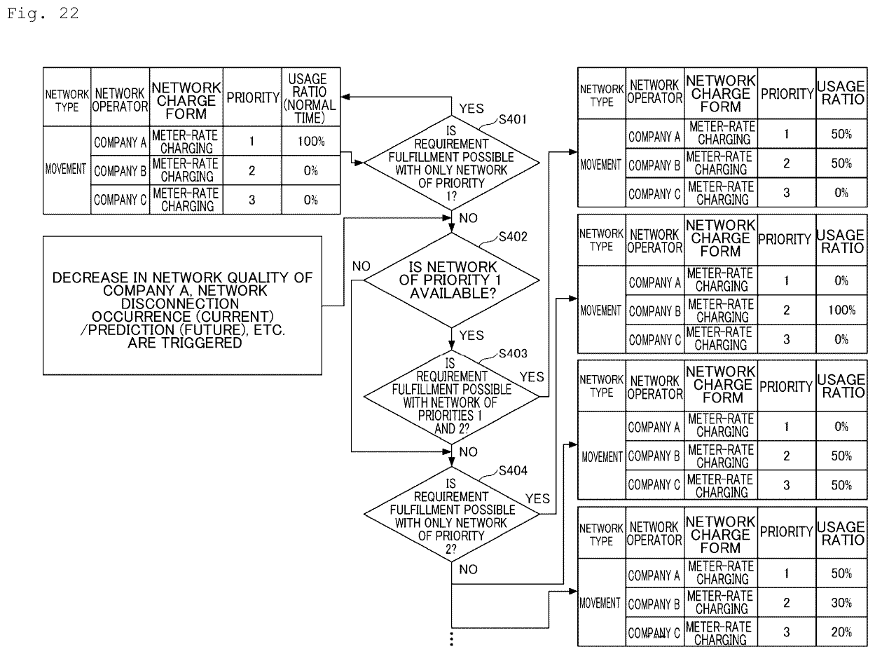

An example of a determination logic by which the network usage mode determination unit 160 determines a network used by the information transmission device 10 will be described with reference to FIG. 22. Meanwhile, the network used by the information transmission device 10 may also be used by the information reception device 20, or the network used by the information reception device 20 may be decided using the same determination logic as the information transmission device 10.

In each table shown in FIG. 22, the network type, network operator, network usage mode, and priority are information stored in the storage unit 150 in advance, and the usage ratio indicates the usage ratio of each network determined (decided) by the network usage mode determination unit 160. Basically, the same applies to Example 5 to 8. However, in Examples 7 and 8, the priority is varied by the network usage mode determination unit 160 (or other functional unit).

In addition, as already described above, the following requirement fulfillment determination can be made based on the measurement result, prediction result, bandwidth requirement, quality requirement, user request, and the like.

The priority setting shown in each table of FIG. 22 may be setting based on the user request, or may be setting based on the network side request. The priority setting value shown in each table of FIG. 22 means that all packets are normally transmitted through NW-A, and another company's network is used in response to a decrease in a network quality of NW-A or a packet redundancy request. Meanwhile, the usage ratio shown in each table is an example. The maximum bandwidth may be specified instead of the usage ratio.

In S401, the network usage mode determination unit 160 determines whether the requirements can be fulfilled only with the NW-A of priority 1. In a case where the determination in S401 is Yes, the network usage mode determination unit 160 determines that only the NW-A is used. The determination process of S401 is repeated, for example, periodically.

For example, in a case where a decrease in the quality of NW-A or network disconnection occurs (current event), or a decrease in the quality of NW-A or network disconnection is predicted (future event), the determination result in S401 is No.

The above current event can be determined by acquiring current information from a decoder (application layer) or CPE: Customer Premises Equipment (network layer) (reference information example: MDI, VMAF, video bit rate, delay, packet loss rate).

In addition, the above future event can be determined by acquiring future information from a wireless network quality prediction function (network layer) (reference information example: throughput, delay, packet loss rate, jitter).

Meanwhile, both a decrease in the quality of the network or disconnection thereof as a current event and a decrease in the quality of the network or disconnection thereof as a future event are examples of “network state.”

In a case where the determination result in S401 is No, the process proceeds to S402. In S402, the network usage mode determination unit 160 determines whether the NW-A of priority 1 is available. In a case where the determination result in S402 is Yes, the process proceeds to S403, and in a case where it is No, the process proceeds to S404.

In S403, the network usage mode determination unit 160 determines whether the requirements can be fulfilled by using both the NW-A of priority 1 and the NW-B of priority 2. In a case where the determination result in S403 is Yes, the network usage mode determination unit 160 determines that both the NW-A and the NW-B are used. That is, from 100% use of the NW-A of priority 1, the usage ratio of the NW-B of priority 2 is increased to fulfill the requirements.

In addition, instead of the usage ratio, the maximum bandwidth may be set to, for example, NW-A: unlimited, NW-B: 10 Mbps, and NW-C: 0 Mbps.

In a case where the determination result in S403 is No, the process proceeds to S404. In S404, the network usage mode determination unit 160 determines whether the requirements can be fulfilled only with the NW-B of priority 2. In a case where the determination result in S404 is Yes, the network usage mode determination unit 160 determines that only the NW-B is used. That is, the usage ratio of the NW-B is set to 100%.

In addition, instead of the usage ratio, the maximum bandwidth may be set to, for example, NW-A: 0 Mbps, NW-B: 10 Mbps, and unlimited: 0 Mbps.

In a case where the determination result in S404 is No, the same determination as described above is performed on a combination of separate networks. As a result, for example, communication in which the usage ratio of the NW-B is set to 50% and the usage ratio of the NW-C is set to 50% is performed.

In a case where the requirements cannot be fulfilled in the network status to be referenced, for example, one or a plurality of operations of the following (1) to (4) may be performed. The same applies to Example 5.
(1) Information transmission in a form which is most asymptotic to requirement fulfillment
(2) Information transmission in a default form (default setting form)
(3) The information generation device 30 reconfigures information (the information transmission device 10 rejects/returns the transmission request of the information generation device 30)
(4) Alert notification to user/operator

### Example 5

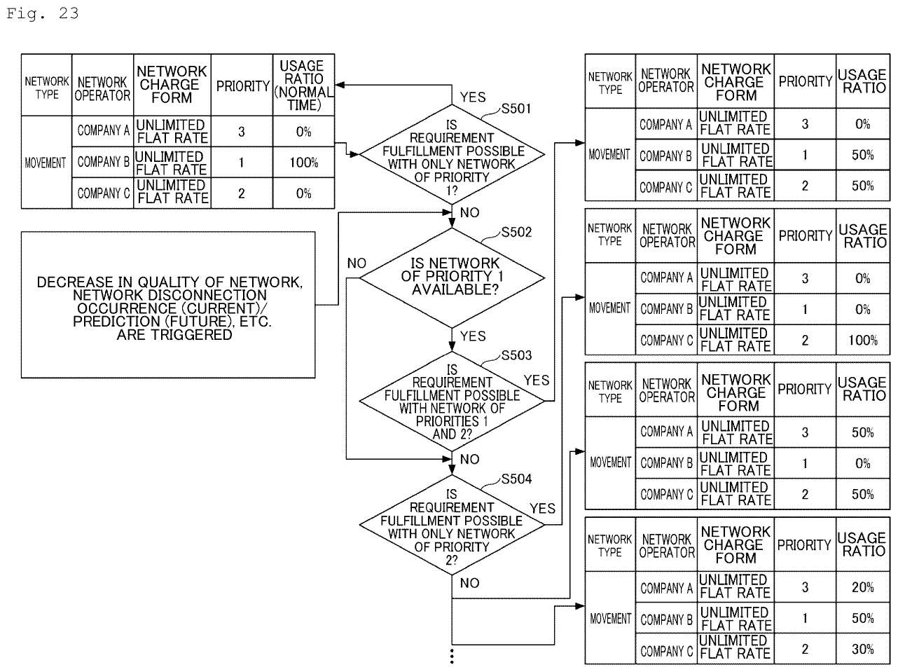

Next, Example 5 will be described with reference to FIG. 23. Example 5 is the same as Example 4 in terms of the processing logic, but the priority values differ from each other. That is, in Example 5, all packets are normally transmitted through networks other than the NW-A. The ratio shown in each table is an example. Here, NW-A-side resource efficiency/economic rationality is emphasized, and the NW-A is used in response to a decrease in the quality of the used network or a packet redundancy request.

In S501, the network usage mode determination unit 160 determines whether the requirement can be fulfilled only with the NW-B of priority 1. In a case where the determination in S501 is Yes, the network usage mode determination unit 160 determines that only the NW-B is used. The determination process of S501 is repeated, for example, periodically.

In a case where the determination result in S501 is No due to the same trigger as in Example 4, the process proceeds to S502. In S502, the network usage mode determination unit 160 determines whether the NW-B of priority 1 is available. In a case where the determination result in S502 is Yes, the process proceeds to S503, and in a case where it is No, the process proceeds to S504.

In S503, the network usage mode determination unit 160 determines whether the requirements can be fulfilled by using both the NW-B of priority 1 and the NW-C of priority 2. In a case where the determination result in S503 is Yes, the network usage mode determination unit 160 determines that both the NW-B and the NW-C are used. That is, from 100% use of the NW-B of priority 1, the usage ratio of the NW-C of priority 2 is increased to fulfill the requirements.

In a case where the determination result in S503 is No, the process proceeds to S504. In S504, the network usage mode determination unit 160 determines whether the requirements can be fulfilled only with the NW-C of priority 2. In a case where the determination result in S504 is Yes, the network usage mode determination unit 160 determines that only the NW-C is used. That is, the usage ratio of the NW-C is set to 100%.

In a case where the determination result in S504 is No, the same determination as described above is performed on a combination of separate networks. As a result, for example, communication in which the usage ratio of the NW-A is set to 50% and the usage ratio of the NW-C is set to 50% is performed.

### Example 6

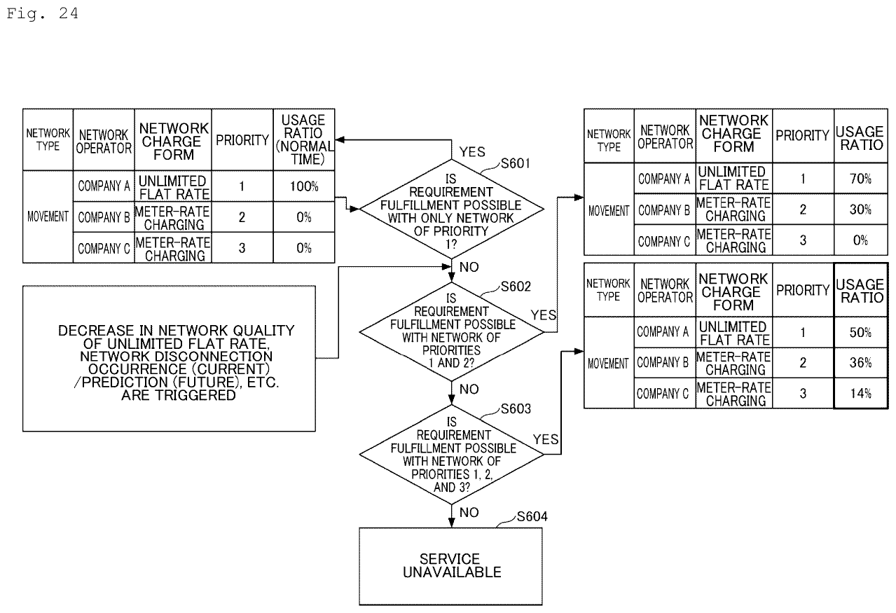

Next, Example 6 will be described with reference to FIG. 24. Example 6 is also an example in which the use of multi-access networks is implemented by lowering it to the usage “priority” for each network. However, the “priority” in Example 6 is the priority seen from the service user side (resource user such as an agricultural operator).

In Example 6, all packets are normally transmitted through the NW-A of an unlimited flat rate, and networks with different coverage or the like are used in response to a decrease in a network quality of the NW-A of an unlimited flat rate or a packet redundancy request. Therefore, the priority of the NW-A is set to 1.

In S601, the network usage mode determination unit 160 determines whether the requirement can be fulfilled only with the NW-A of priority 1. In a case where the determination in S601 is Yes, the network usage mode determination unit 160 determines that only the NW-A is used. The determination process of S601 is repeated, for example, periodically.

In a case where the determination result in S601 is No, the process proceeds to S602. In S602, the network usage mode determination unit 160 determines whether the requirements can be fulfilled by using both the NW-A of priority 1 and NW-B of priority 2. In a case where the determination result in S603 is Yes, the network usage mode determination unit 160 determines that both the NW-A and the NW-B are used. That is, from 100% use of the NW-A of priority 1, the usage ratio of the NW-B of priority 2 is increased to fulfill the requirements.

In addition, instead of the usage ratio, the maximum bandwidth may be set to, for example, NW-A: unlimited, NW-B: 10 Mbps, and NW-C: 0 Mbps.

In a case where the determination result in S602 is No, the process proceeds to S603. In S603, the network usage mode determination unit 160 determines whether the requirements can be fulfilled by using all of the NW-A of priority 1, the NW-B of priority 2, and the NW-C of priority 3. In a case where the determination result in S603 is Yes, the network usage mode determination unit 160 determines that the NW-A, the NW-B, and the NW-C are used. In the example of FIG. 24, the usage ratio is set to “50%:36%:14%.”

In addition, instead of the usage ratio, the maximum bandwidth may be set to, for example, NW-A: unlimited, NW-B: 10 Mbps, and unlimited: 5 Mbps. In a case where the determination result in S603 is No, it is determined in S604 that the service cannot be provided.

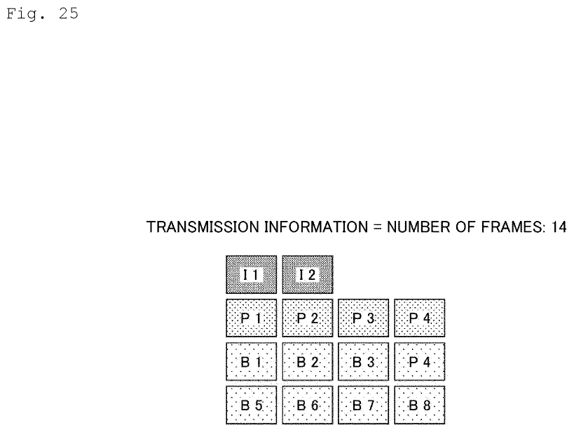

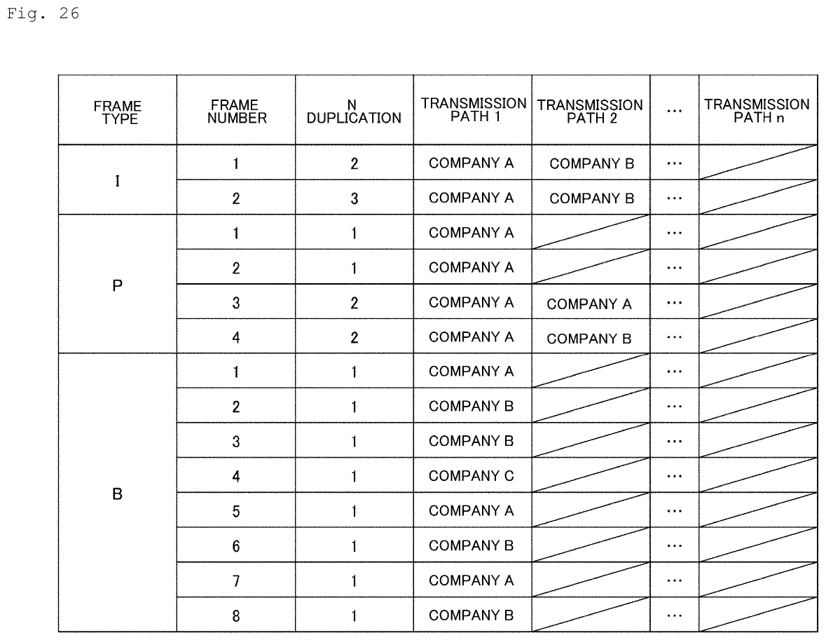

In a case where a plurality of networks are used, an example of transmission control according to the usage ratio will be described with reference to FIGS. 25 and 26. Here, it is assumed that there are 14 frames as transmission information transmitted by the information transmission device 10 as shown in FIG. 25.

### <Instance 1>

In Instance 1, control is performed only by the usage ratio. In this case, assuming that the usage ratio is “50%:36%:14%,” the number of frames to be transmitted by each network in 14 frames is as follows.

$$NW - A ( 50 \% ) = 7$$

$$NW - B ( 36 \% ) = 5$$

$$NW - C ( 14 \% ) = 2$$

The control in Instance 1 can be realized, for example, by notifying the information transmission device 10 of the usage ratio from the network usage mode setting unit 180.

### <Instance 2>

In Instance 2, information as shown in FIG. 26 is created on the basis of the decided usage ratio, and the information transmission device 10 is notified of the information from the network usage mode setting unit 180.

FIG. 26 shows information in which a transmission path according to the characteristics of the frame is designated for each frame. In the case of adopting a redundant configuration, a plurality of transmission paths are designated for each frame. In this case, the number of frame to be transmitted is 19. The actual control involves, for example, determining the upper limit of each path to distribute the frames and asymptotically approaching the set information, and the final usage ratio is determined by the transmission result.

In addition to Instances 1 and 2, n (the number of redundancies) and each transmission path may be set in consideration of both the frame type and network quality, and various variations are assumed in the control of allocation/grading during information duplication and multipath mode.

### Example 7

Next, Example 7 will be described. In Example 7, an example in which the usage “priority” of the wireless access network is varied depending on the base station arrangement status will be described. Here, an example of operating under a particularly quality-oriented policy will be described.

Meanwhile, in Examples 7 and 8, changing the priority/usage ratio (deciding the priority/usage ratio) may be performed by the network usage mode determination unit 160, or may be performed by other functional units.

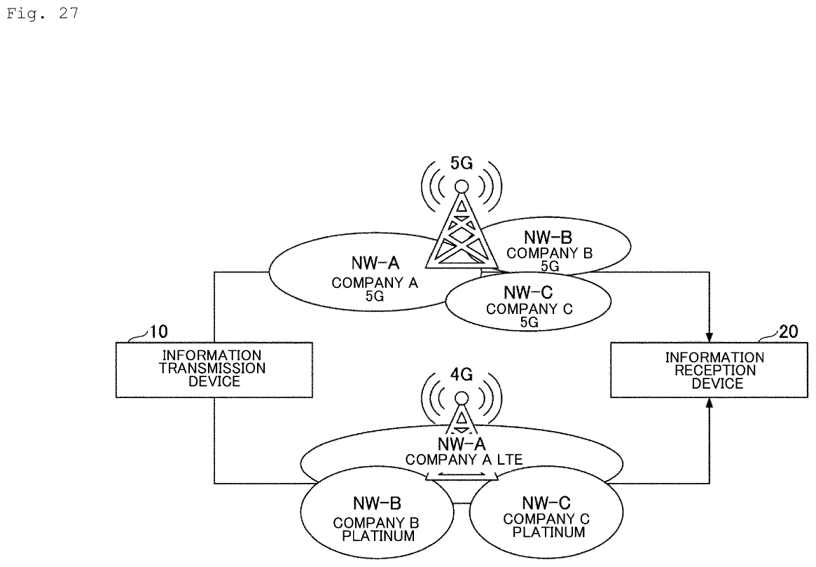

In Example 7, the network configuration shown in FIG. 27 is assumed. The bands operated by each of NW-A (5G), NW-B (5G), NW-A (LTE), NW-B (platinum), and NW-C (platinum) are determined in advance.

In Example 7, the profit is emphasized, and all packets are normally transmitted through the NW-A. The networks of other companies are used in response to a decrease in a network quality of the NW-A or the packet redundancy request. The usage ratio is, for example, varied moderately in accordance with a quality-oriented policy.

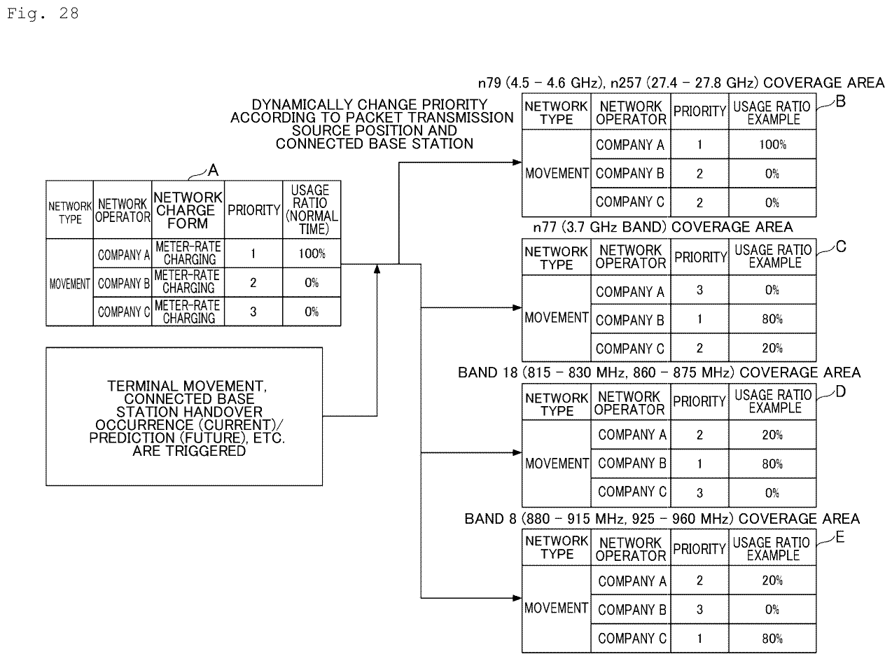

A in FIG. 28 shows a normal state. That is, in a normal time, the network usage mode determination unit 160 determines that the information transmission device 10 is allowed to use the NW-A 100%.

For example, the situation changes when a handover of the base station to which the information transmission device 10 is connected occurs (current event) or when handover occurrence is predicted (future event) due to the movement of the information transmission device 10 or a change in the wireless status. Examples after the change are shown in B and C of FIG. 28.

The above current event can be determined by acquiring current information from a device or a function of managing the resource status (reference information example: time/position information, base station arrangement status).

In addition, the above future event can also be determined by acquiring future information from a device or a function of managing the resource status (reference information example: time/position information, base station arrangement status).

As shown in B of FIG. 28, in a case where the information transmission device 10 moves to the coverage area of n79 (4.5-4.6 GHz) or n257 (27.4-27.8 GHz) operated by the NW-A (5G), the priority is set to “1:2:2” in order to use broadband communication, for example, the usage ratio of the NW-A is set to 100%.

As shown in C, in a case where the information transmission device 10 moves to the coverage area of n77 (3.7 GHz band) operated by the NW-B (5G) and the NW-C (5G), the priority is set to “3:1:2,” and the usage ratio is set to, for example, “0%:80%:20%.”

As shown in D, in a case where the information transmission device 10 moves to the coverage area of band 18 (815-830 MHz, 860-875 MHz) operated by the NW-B (platinum), the priority is set to “2:1:3,” and the usage ratio is set to, for example, “20%:80%:0%.”

As shown in E, in a case where the information transmission device 10 moves to the coverage area of band 8 (880-915 MHz, 925-960 MHz) operated by the NW-C (platinum), the priority is set to “2:3:1,” and the usage ratio is set to, for example, “20%:0%:80%.”

### Example 8

Next, Example 8 will be described. In Example 8, an example in which the usage “priority” of the wireless access network is varied depending on the capacity consumption status of the network usage contract will be described.

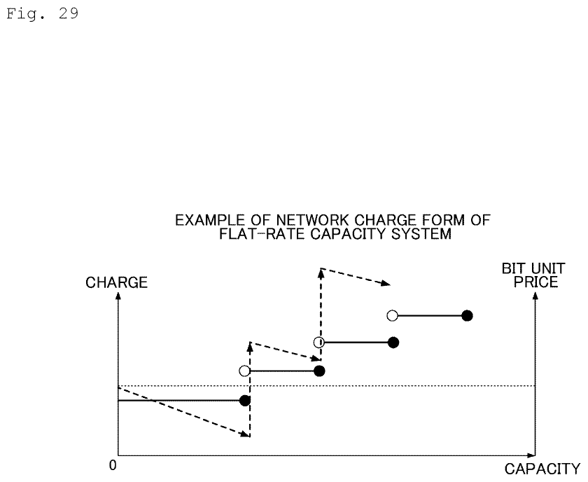

In Example 8, it is assumed that the network charge form of each network is a flat-rate capacity system. FIG. 29 shows an example of the network charge form for a flat-rate capacity system. In FIG. 29, the thick solid line indicates the charge that increases stepwise in accordance with the used capacity (the vertical axis is on the left), and the thick dotted line indicates the bit unit price at each stage (the vertical axis is on the right). The maximum capacity for which the charge remains flat is called “flat-rate capacity.”

The bit unit price for the additional portion (portion of the second and subsequent stages) is usually higher than the capacity of the initial stage. In the case of a two-stage flat rate (the second stage is an unlimited flat rate) as in a service provided by a certain company, it may shift to the same operation as in Example 5 (priority use of the unlimited flat-rate NW).

In Example 8, the network usage amount is normally leveled. Meanwhile, the NW-A is given priority under the same conditions. In addition, priority is given to using up the flat-rate capacity so that the capacity addition (increase in the charge level in the example of FIG. 29) is minimized. That is, the priority is varied before and after the capacity addition is required.

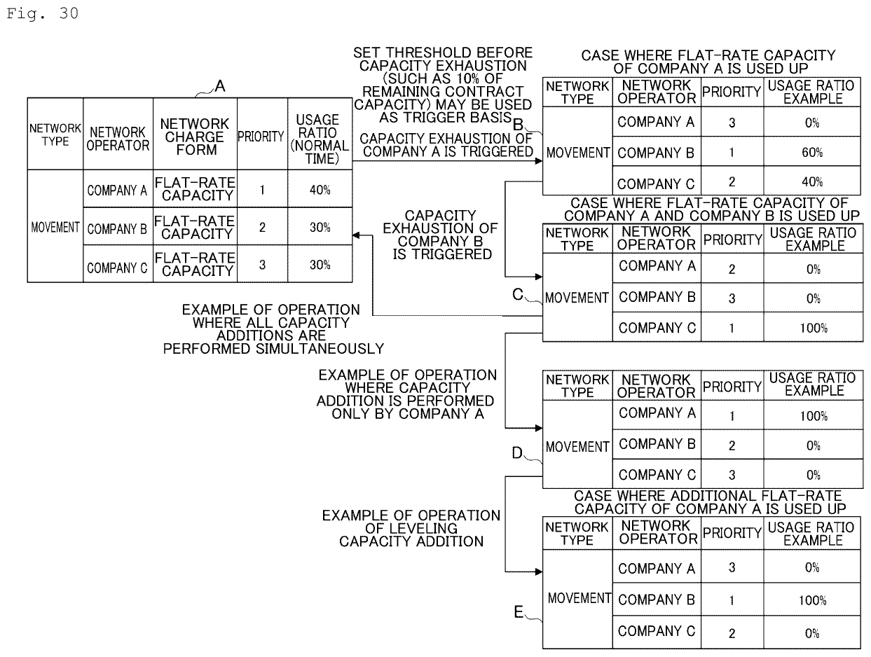

Hereinafter, an example of control related to a certain information transmission device 10 will be described with reference to FIG. 30. Meanwhile, the priorities and usage ratios shown in FIG. 30 are examples. In addition, in the following example, the exhaustion of the flat-rate capacity (using up the capacity) is used as a trigger, but the set threshold before the capacity exhaustion (such as 10% of the remaining contract capacity) may be used as a trigger basis.

A in FIG. 30 shows a normal state. That is, in a normal time, the network usage mode determination unit 160 sets the priority of the NW-A, the NW-B, and the NW-C to “1:2:3,” and sets the usage ratio to “40%:30%:30%.”

When the information transmission device 10 detects that the flat-rate capacity of the NW-A has been used up, the network usage mode determination unit 160 sets the priority to “3:1:2” and sets the usage ratio to “0%:60%:40%” as shown in B.

Next, when the information transmission device 10 detects that the flat-rate capacity of the NW-B has been further used up, the network usage mode determination unit 160 sets the priority to “2:3:1” and sets the usage ratio to “0%:0%:100%” as shown in C.

When the information transmission device 10 detects that the flat-rate capacity of all networks has been used up, the network usage mode determination unit 160 sets the priority to “1:2:3” and sets the usage ratio to “100%:0%:0%” as shown in D. Meanwhile, here, it is assumed that the capacity addition will be carried out only by the NW-A (Company A).

Thereafter, when the information transmission device 10 detects that the additional flat-rate capacity of the NW-A has been used up, the network usage mode determination unit 160 sets the priority to “3:1:2” and sets the usage ratio to “0%:100%:0%” as shown in E. Meanwhile, here, it is assumed that the capacity addition will also be leveled.

According to Example 8, the resource usage cost of the service user can be reduced on the premise that the requirements related to the quality of information transmission are fulfilled.

For the dynamic change of priority as in Example 8, in addition to the automatic change mode on the system according to a request for service use, a service user-initiated change mode (separation of functions of detection and control) based on notification (recommendation) to the service user may be adopted.

Meanwhile, the capacity usage (current value, prediction value), current position, and future position of the device (terminal) are all examples of “device state.”

### (Other Instances)

In the control apparatus 100 according to the present embodiment, the operations described in the following <Instance 1> to <Instance 10> can also be performed. The following operations may be performed by any of the prediction unit, the measurement unit, the determination unit, and the setting unit in the control apparatus 100.

### <Instance 1>

For the device position, the control apparatus 100 predicts the future position with a high degree of accuracy from any one or more of a past movement history, current surrounding environmental conditions (such as event information, traffic light status, or road construction schedule), an operation plan, and device characteristics. In addition, based on this, network quality and information quality of video or the like are predicted, and the network usage mode is determined. In addition, information setting of video or the like may be determined and set.

### <Instance 2>

The control apparatus 100 predicts network quality and information quality of video or the like by referring to the history of changes in device status (such as position or surrounding environment), network quality (such as bandwidth or delay), and information quality of video or the like (such as MDI, VMAF, bit rate, or MOS value), refers to, when the setting is determined, values obtained by multiplying the prediction result by a large coefficient close to 1 (example: 1−x/100) if the difference between the previous prediction result (or setting result) and the measurement result is equal to or less than x % (example: 5%) and obtained by multiplying the prediction result by a small coefficient close to 0 (example: 1-2y/100) if the difference is equal to or greater than y % (example: 20%) as the prediction value, and reflects the values in the determination result. This makes it possible to avoid unexpected quality deterioration of information on video or the like.

### <Instance 3>

The control apparatus 100 may set reliability/accuracy for future prediction, and utilize the reliability as a coefficient or a threshold at the time of determination. For example, the reliability is converted into a coefficient and multiplied by the prediction value, and in a case where it falls below a certain reliability, a specially low coefficient is multiplied or treated as 0.

### <Instance 4>

the control apparatus 100 may set the determination logic on the basis of not only a cost-minimum determination considered as a user request but also a response policy or charging policy on the side providing the wireless access network and server resources. For example, a buffer may be provided with emphasis on mission criticality to provide resources, preferentially use resources of a meter-rate charging system, or the like.

### <Instance 5>

The control apparatus 100 may perform more flexible setting by dynamically varying the setting mechanism itself through the utilization of machine learning approach/AI in addition to setting based on pre-measurement or fixed rule-based determination logic.

### <Instance 6>

The control apparatus 100 may assume a situation in which the determination result of the network usage mode cannot be applied due to a sudden change in situation or the like, extract the second and third determination results in a determination stage, and apply the second or third determination result with the occurrence of an unapplicable event as a trigger.

### <Instance 7>

In the control apparatus 100, the network usage mode setting unit 180 may detect a situation in which the determination result of the above network usage mode cannot be applied due to a sudden change in situation or the like and notify the network usage mode determination unit 160. At the same time, a fail-safe mechanism specified in advance may be applied temporarily, or an attempt may be made to apply the second and third determination results which are notified of in advance.

### <Instance 8>

The control apparatus 100 may determine and apply the cheapest network usage mode (including a timing or method of network switching/bonding) from the total amount of information transmission for a certain period and the bit unit price/charge system of the network use for transmission. In addition, choices for network usage modes recommended according to the purpose of an improvement in transmission quality or a reduction in cost may be presented to the user or the like, and the network usage mode may be selected/applied on the basis of the selection result.

### <Instance 9>

The control apparatus 100 may utilize one or more of the network usage mode determination result, the determination result of information setting of video or the like, and various measurements/prediction values for cooperative operations/control functions (such as, for example, device control) other than the system related to the transmission of information on video or the like. In addition, when the determination result or the like is utilized, the future prediction may also be notified together with the reliability/accuracy of the prediction.

### <Instance 10>

The control apparatus 100 may utilize the congestion status (and expected congestion) of the wireless base station as a specific example of the network status to be referenced. In addition, the correlation between these and the device status such as a radio wave propagation environment or an actual network quality may be analyzed and reflected in the network quality prediction and network usage mode determination.

### <Instance 11>

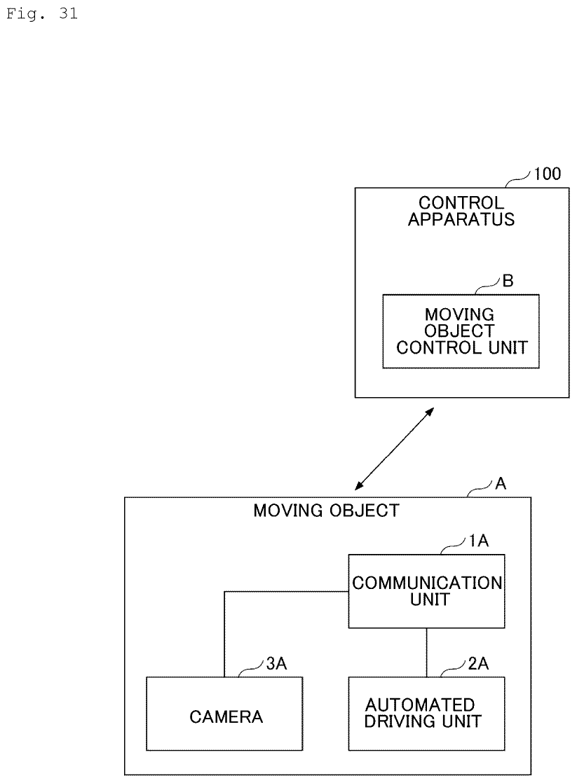

As shown in FIG. 31, the technique according to the present embodiment can also be applied to an automatically traveling moving object (hereinafter referred to as a moving object A) such as an automated driving vehicle. The moving object A may be an automobile, an agricultural machine, a construction vehicle such as a shovel car, or something other than these. In addition, the moving object A may be referred to as a “device.”

The moving object A includes the function of the information transmission device 10 and the function of the information generation device 30 in the present embodiment together with an automated driving unit 2A which is a functional unit for performing automated driving.

Specifically, the moving object A includes a communication unit 1A that communicates wirelessly through the network, and a camera 3A. The video captured by the camera (video around the moving object A) is sent to the control apparatus 100 by the communication unit 1A. Meanwhile, the video is an example of “information.”

In addition, in Instance 11, the control apparatus 100 includes a moving object control unit B. The moving object control unit B can analyze the video received from the moving object A, and instruct the automated driving unit 2A of the moving object A to stop or the like, for example, when it detects that the moving object A is in a dangerous state (example: an oncoming vehicle is approaching). Meanwhile, since the moving object control unit B includes a setting function, it may be referred to as a setting unit.

The communication unit 1A and the camera 3A can each receive reactive and proactive control from the control apparatus 100 as described so far in the present embodiment.

In Instance 11, control in which three of network control for the communication unit 1A, video control for the camera 3A, and control related to traveling of automated driving are interlocked can be performed. Examples of control are shown in the following S1 to S3. Meanwhile, the following control is an example. In addition, “determination based on the actual measurement value” and “determination based on the prediction value” described above may be combined.

### <S1>

When the network quality deteriorates, the video transmitted from the moving object A to the moving object control unit B deteriorates, and the moving object control unit B may not be able to appropriately control the moving object A. The deterioration of the video includes, for example, video stopping due to a decrease in the bandwidth (throughput) of the network, and the like.

Consequently, when the network quality prediction unit 130 of the control apparatus 100 predicts that the network quality (example: bandwidth, delay, packet loss, or the like) deteriorates below a threshold determined in advance with respect to communication of the moving object A (for example, predicts that it deteriorates after 1 second), the network usage mode determination unit 160 decides the network usage mode (example: changing from one network connection to two network connections) for improving the network quality, and sets the network usage mode from the network usage mode setting unit 180 to the communication unit 1A. Meanwhile, “bandwidth, delay, packet loss, or the like” here is an example of “quality related to information transmission,” and “threshold” is an example of “requirements related to information transmission.”

Thereafter, if the network quality improves through the setting change and there is no problem in the video, this state is continued.

### <S2>

“When the network quality remains deteriorated below a threshold with only control in S1, or when there is a problem with the quality of the video received by the moving object control unit B (the video is intermittently interrupted or the like)” (determination based on the actual measurement value), or “when it is predicted that the network quality remains deteriorated below the threshold with only control in S1, or when it is predicted that a problem will occur in the quality of the video received by the moving object control unit B” (for example, determination based on the prediction value after 1 second), the information determination unit 170, for example, makes a determination to decrease the video quality (example: resolution, frame rate) of the camera 3A, and sets the determined setting information from the information setting unit 190 to the camera 3A. When the setting of video quality decrease is performed, the video quality may be decreased by a width determined in advance (example: changing the frame rate from 30 FPS to 10 FPS), for example, in one decrease setting.

Thereafter, if no problem occurs with the video due to the above setting change, this state is continued.

### <S3>

“When the network quality remains deteriorated below a threshold with only control in S1 and S2, or when there is a problem with the quality of the video received by the moving object control unit B” (determination based on the actual measurement value), or “when it is predicted that the network quality remains deteriorated below the threshold with only control in S1 and S2, or when it is predicted that a problem will occur in the quality of the video received by the moving object control unit B” (for example, determination based on the prediction value after 1 second), the moving object control unit B instructs the automated driving unit 2A of the moving object A to decrease the speed, change the path, stop, or the like so that safety can be ensured even if sufficient video cannot be obtained.

Hereinbefore, the first embodiment has been described.

### Second Embodiment

Next, a second embodiment will be described. In the second embodiment, the QoS (Quality of Service) control level of the network is added to the first embodiment as a target for cooperative control. Except for this point, the first embodiment and the second embodiment are the same as each other. In the second embodiment, the QoS control level of the network can be controlled in any of the configurations and operations described in the first embodiment. The control method for the QoS control level is not limited to a specific method, and may be dynamic control or static control.

Meanwhile, in the second embodiment, the QoS control level is used as an example of communication priority. Something other than the “QoS control level” may be used as the “communication priority.”

More specifically, in the second embodiment, the network quality is measured and predicted for each network QoS control level, and the network usage mode to be determined includes the QoS control level of the network.

In addition, in the second embodiment, the network usage mode can be controlled for each network QoS control level. For example, in Examples 4 to 8 of the first embodiment, the network usage mode can be controlled by performing priority setting and usage ratio setting among “NW-A of QoS control level 1,” “NW-A of QoS control level 2,” “NW-A of QoS control level 3,” “NW-B of QoS control level 1,” “NW-B of QoS control level 2,” and “NW-C”. That is, a level of priority is allocated to each network for each QoS control level, and the network usage mode determination unit 160 can decide the usage ratio for each QoS control level of each network as the network usage mode on the basis of the allocated level of priority.

The system configuration, device configuration, and operating sequence (processing flow) in the second embodiment are basically the same as the system configuration, device configuration, and operating sequence (processing flow) in the first embodiment. It differs from the first embodiment in that the QoS control level of the network is added as a target of cooperative control.

An example of information exchanged between functional units in the second embodiment will be described with reference to FIG. 3 (Configuration example 1) and FIG. 4 (Configuration example 2).

### FIG. 3: Configuration Example 1

The network quality measurement unit 110 acquires the network quality measurement result for each QoS control level from the information reception device 20, and stores the acquired network quality measurement result for each QoS control level in the storage unit 150. The information quality measurement unit 120 acquires information quality measurement results from the information utilization device 40 and stores the acquired information quality measurement results in the storage unit 150.

The network quality prediction unit 130 acquires “the situation on the device area side, variation history of network quality, results of relationship/correlation evaluation between network quality prediction results based on the situation on the device side and measurement results, and the like” for each QoS control level from the storage unit 150, predicts network quality for each QoS control level on the basis of any one or more of these pieces of information, and stores the network quality prediction result for each QoS control level in the storage unit 150.

The information quality prediction unit 140 acquires “the situation on the device/information processing area side, variation history of network/information quality, results of relationship/correlation evaluation between information quality prediction results based on the situation on the device/network area side and measurement results, and the like” from the storage unit 150, performs information quality prediction on the basis of any one or more of these pieces of information, and stores the information quality prediction results in the storage unit 150.

The network usage mode determination unit 160 acquires “information transmission requirements, the situation on the device area side, variation history of network quality, the network quality prediction results (including reliability/accuracy), results of relationship/correlation evaluation between network usage mode determination results based on the situation on the device/network area side and network/information quality measurement results, and the like” from the storage unit 150. Meanwhile, the variation history of network quality and the network quality prediction result are information for each QoS control level.

The network usage mode determination unit 160 performs network usage mode determination using any one or more of these pieces of information, stores the network usage mode determination result in the storage unit 150, and notifies the information setting determination unit 170 and the network usage mode setting unit 180 of the network usage mode determination result. The network usage mode determination result determined by the network usage mode determination unit 160 includes the QoS control level for the network that performs QoS control.

The information setting determination unit 170 acquires “information transmission requirements, the situation on the device/information processing area side, variation history of network/information quality, network/information quality prediction results (including reliability/accuracy), and results of relationship/correlation evaluation between information setting determination results based on the situation on the device/network area side and network usage mode determination results and information quality measurement results” from the storage unit 150. Meanwhile, the variation history of network quality and the network quality prediction result are information for each QoS control level.

The information setting determination unit 170 performs information setting determination using any one or more of these pieces of information, stores the information determination result in the storage unit 150, and notifies the information setting unit 190 of the result.

The network usage mode setting unit 180 receives the network usage mode determination result from the network usage mode determination unit 160 and set it in the information transmission device 10. As described above, the network usage mode determination result includes the QoS control level. The information setting unit 190 receives the information setting determination result from the information setting determination unit 170 and performs information setting in the information generation device 30 on the basis of the result.

### FIG. 4: Configuration Example 2

As described in the first embodiment, configuration example 2 is an example in a case where there are a plurality of network usage mode candidates included in the network usage mode determination result. In the second embodiment, the functional units present in configuration example 1 of FIG. 3 and configuration example 2 of FIG. 4 are the same. The main points that differ from configuration example 1 of FIG. 3 will be described. Meanwhile, even in a case where there are a plurality of network usage mode candidates included in the network usage mode determination result, the processing in configuration example 1 may be performed.

In configuration example 2, the network usage mode determination unit 160 obtains the network usage determination result (including the QoS control level) including the reliability/accuracy, and notifies the information setting determination unit 170 of the result. The information setting determination unit 170 determinates information setting, and notifies the network usage mode setting unit 180 of the network usage mode used as the basis for the information setting determination (including the QoS control level).

Hereinafter, Example 2-1 (intent of Example 1 in the second embodiment) and Example 2-2 will be described as specific operation examples in a case where the QoS control level of the network is included as a control target. In both Examples 2-1 and 2-2, the system configuration and device configuration are the same as in the first embodiment, for example, as shown in FIGS. 2 to 4. That is, as shown in FIG. 2, the information transmission device 10 can communicate with the information reception device 20 using any one, any two, or all three of the NW-A, the NW-B, and the NW-C. In the example, the information transmission device 10 may be referred to as a “device.”

in addition, in the following examples, a QoS class identifier (QCI) is used as the value of the QoS control level of the network. The QCI identifies to what extent the network bandwidth (speed), delay, packet loss rate, and the like are guaranteed (or whether the bandwidth is guaranteed). Using the QCI as the value of the QoS control level of the network is an example, and information other than the QCI may be used as the value of the QoS control level of the network.

### Example 2-1

In Example 2-1, the network quality prediction unit 130 predicts the network quality for a certain device (the information transmission device 10) from the time, the device position, and the network quality measurement result (example: quality measured on the reception side), and the network usage mode determination unit 160 determines the network usage mode of the device on the basis of the prediction result. That is, in Example 2-1, an example of proactive control will be described.

Meanwhile, in the processing of the following Example 2-1, it is assumed that the network quality prediction result by the network quality prediction unit 130 is temporarily stored in the storage unit 150, and that the network usage mode determination unit 160 reads out the network quality prediction result from the storage unit 150 and uses it for determination, but there is no limitation to such processing. The network usage mode determination unit 160 may be directly notified of the network quality prediction result obtained by the network quality prediction unit 130.

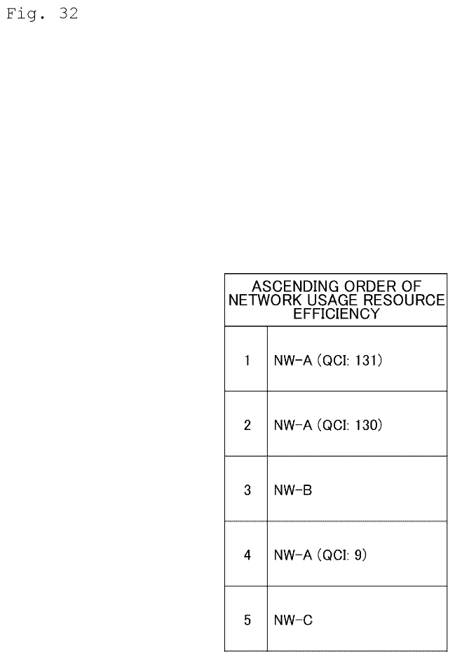

FIG. 32 shows the efficiency of network usage resources in ascending order in the network (including the QCI in the case of a network that performs QoS control) used in Example 2-1. That is, the resource efficiency of the NW-A with QoS control at QCI=131 is the worst, and the resource efficiency of the NW-C is the best.

Resource efficiency being bad means, for example, a situation in which, because a bandwidth is guaranteed, the bandwidth cannot be sufficiently used for other communications even in a case where there is no communication traffic which is a target for bandwidth guarantee. Resource efficiency being good corresponds to, for example, best-effort communication without QoS control. Even among a plurality of QCIs for performing bandwidth guarantee, resource efficiency may be good or bad depending on the degree of bandwidth guarantee and the like.

Thereafter, NW-X in a case where QoS control is performed with QCI=m will be described as NW-X (QCI: m).

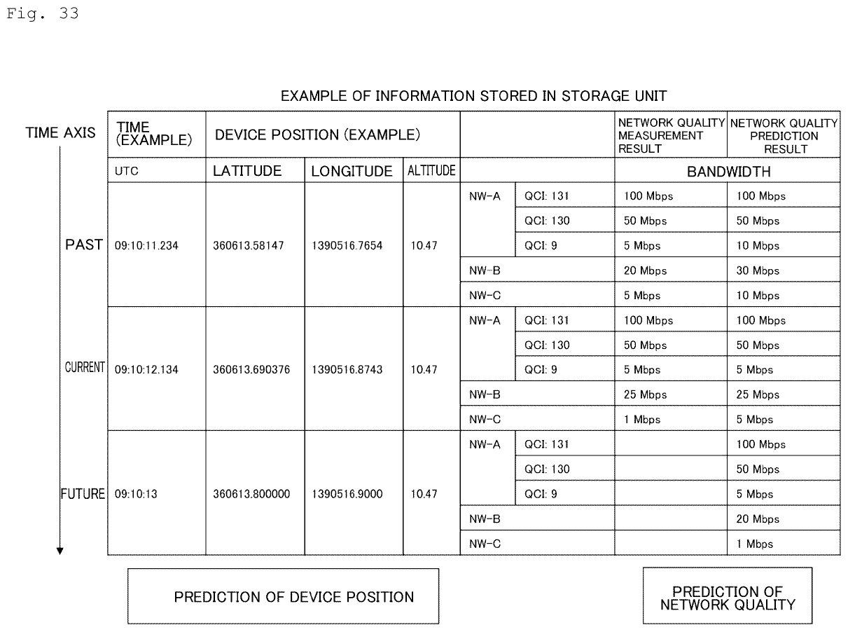

FIG. 33 shows an example of information stored in the storage unit 150 in Example 2-1. As shown in FIG. 33, the storage unit 150 stores values for device positions and network quality prediction results for each time (past, current, future). For the network quality measurement results, past and current values are stored.

The above values are values for each network. In addition, for the network where QoS control is performed, the above values are values for each QCI. For example, at a future time (09:10:13), the network quality prediction result (here, bandwidth prediction result) of the NW-A (QCI=131) is 100 Mbps, the network quality prediction result of the NW-A (QCI=130) is 50 Mbps, and the network quality prediction result of the NW-A (QCI=9) is 5 Mbps. In addition, the network quality prediction result of the NW-B is 20 Mbps, and the network quality prediction result of the NW-C is 1 Mbps.

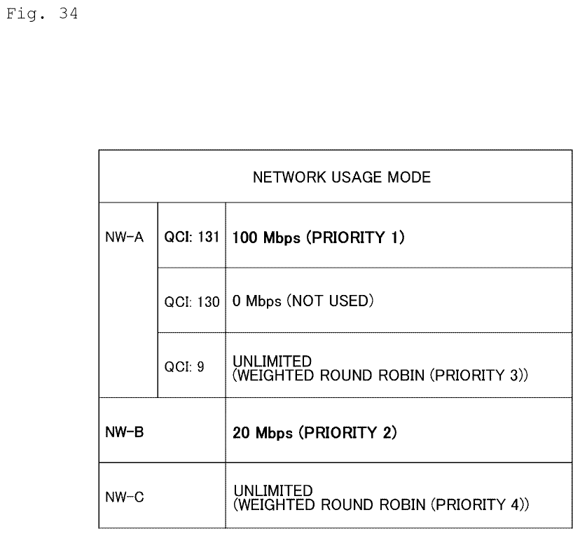

In addition, in Example 2-1, it is assumed that the requirement/request for the device which a target for network usage mode determination is “bandwidth requirement: 120 Mbps, user request: NW-A priority, orientation for high-efficiency use of resources” and that this information is stored in the storage unit 150. FIG. 34 shows an example of network usage mode candidates determined by the network usage mode determination unit 160 on the basis of the prediction values shown in FIG. 33 and “bandwidth requirement: 120 Mbps, user request: NW-A priority, orientation for high-efficiency use of resources.”

In FIG. 34, “100 Mbps (priority 1)” which is a network usage mode for the NW-A (QCI=131) means that the NW-A (QCI=131) is used at the highest priority for 100 Mbps worth of communication in the bandwidth requirement (=120 Mbps). In addition, in this example, the NW-B which is “orientation for high-efficiency use of resources” and in which QoS control is not performed has a projected bandwidth of 20 Mbps, and thus the NW-B is determined to be “20 Mbps (priority 2)” as the network usage mode.

the network usage mode determination unit 160 can basically decide “using the NW-A (CQI=131) and the NW-B” as the network usage mode of the device on the basis of the candidates shown in FIG. 34 obtained by the determination.

In this case, the network usage mode determination unit 160 (or the information setting determination unit 170) notifies the network usage mode setting unit 180 of “using the NW-A (CQI=131) and the NW-B” which is a determination result, and the network usage mode setting unit 180 sets “using the NW-A (CQI=131) and the NW-B” in the device. This allows the device to execute information transmission using the NW-A (CQI=131) and the NW-B.

In addition, the network usage mode determination unit 160 may notify the network usage mode setting unit 180 of the information shown in FIG. 34, and the network usage mode setting unit 180 may set the information shown in FIG. 34 in the device.

The device having received the information shown in FIG. 34 basically performs information transmission using the NW-A (CQI=131) and the NW-B on the basis of priority information, and in a case where the bandwidth is insufficient, the device can use both the “NW-A (QCI=9)” or the “NW-A (QCI=9) and the NW-C in addition to the NW-A (CQI=131) and the NW-B.

When both the NW-A (QCI=9) and the NW-C are used, the NW-A (QCI=9) and the NW-C may be alternately used in a weighted round robin. Meanwhile, the usage time of one network becomes longer by the amount of weighting.

Meanwhile, proactive control as in Example 2-1 may be performed at time intervals determined in advance, or may be performed in a case where a change equal to or greater than a threshold determined in advance occurs in the network quality prediction result for the network in use.

### Example 2-2

Next, Example 2-2 will be described. In Example 2-2, an example in which the network usage mode determination unit 160 changes the network usage mode for a certain device (the information transmission device 10) from the time, the device position, and the network quality measurement result (example: quality measured in the reception side) will be described. That is, in Example 2-2, an example of reactive control will be described.

Meanwhile, in the processing of the following Example 2-2, it is assumed that the time/position information and the network quality measurement result acquired by the network quality measurement unit 130 are temporarily stored in the storage unit 150, and that the network usage mode determination unit 160 reads out the information from the storage unit 150 and uses it for determination, but there is no limitation to such processing. The network usage mode determination unit 160 may be directly notified of the time/position information and the network quality measurement result acquired by the network quality measurement unit 130.

The efficiency of network usage resources in Example 2-2 is the same as in Example 2-1, and is as shown in FIG. 32. In addition, similarly to Example 2-1, NW-X in a case where QoS control is performed at QCI=m is described as NW-X (QCI: m).

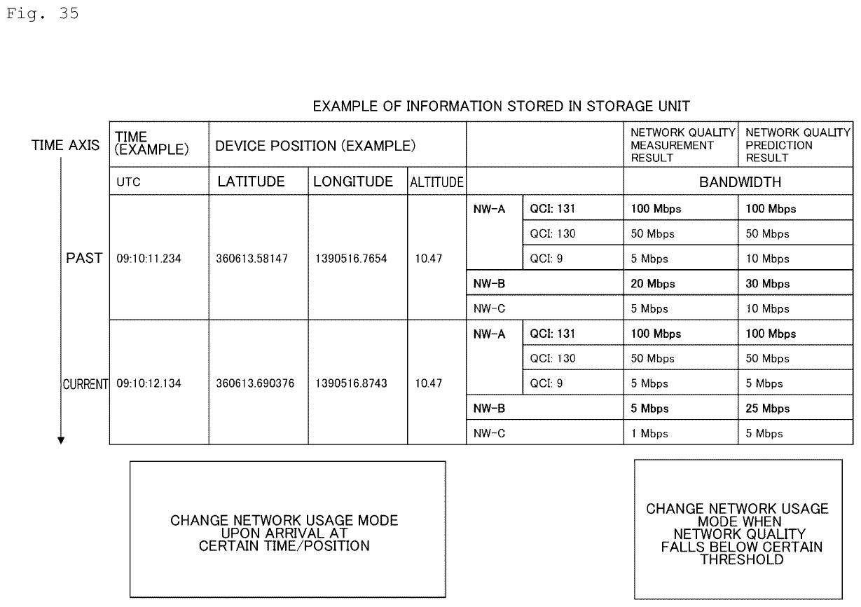

FIG. 35 shows an example of information stored in the storage unit 150 in Example 2-2. As shown in FIG. 35, the storage unit 150 stores past and current values for the device position, the network quality measurement result, and the network quality prediction result.

The above values are values for each network. In addition, for the network where QoS control is performed, the above values are values for each QCI. For example, at the current time (09:10:12.134), the network quality measurement result of the NW-A (QCI=131) is 100 Mbps, the network quality measurement result of the NW-A (QCI=130) is 50 Mbps, and the network quality measurement result of the NW-A (QCI=9) is 5 Mbps. In addition, the network quality measurement result of the NW-B is 5 Mbps, and the network quality measurement result of the NW-C is 1 Mbps.

In Example 2-2, the requirement/request for the device which a target for network usage mode determination are the same as in Example 2-1, and “bandwidth requirement: 120 Mbps, user request: NW-A priority, orientation for high-efficiency use of resources” is stored in the storage unit 150.

In Example 2-2, first, the device is assumed to perform information transmission using the NW-A (QCI=131) and the NW-B on the basis of the determination and setting in Example 2-1.

Here, it is assumed that the network quality measurement result in the NW-B deteriorates from 25 Mbps to 5 Mbps at a certain current time as shown in FIG. 35. Such a situation is assumed to be, for example, a situation in which the device has moved to the peripheral portion of the NW-B area (cell) at that time, or a situation in which there is a high building or the like between the base station of the NW-B and the device. Alternatively, it is assumed that at that time, the NW-B has become congested due to an increase in the number of other devices in the NW-B area.

For example, when it is detected that the network quality falls below a certain threshold on the basis of the network quality measurement result, the network usage mode determination unit 160 changes the network usage mode. Here, the networks which are targets for comparison with the threshold are currently used networks (in this example, the NW-A (CQI=131) and the NW-B), but there is no limitation thereto.

In this example, for example, when the threshold for the network quality measurement result of the NW-B is 10 Mbps, at the current time in FIG. 35, the network quality measurement result of the NW-B is 5 Mbps, which falls below the threshold.

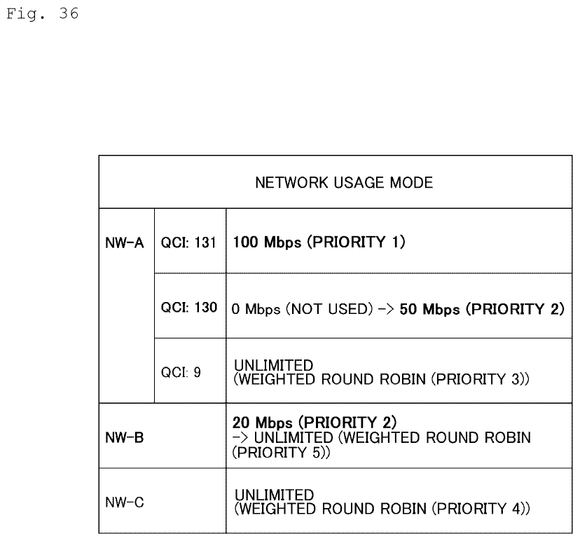

Thus, the network usage mode determination unit 160 changes the network usage mode candidate to the mode shown in FIG. 36 on the basis of the current network quality.

As shown in FIG. 36, in this example, the determination result for the “NW-A (QCI=130)” changes from “0 Mbps (not used)” to “50 Mbps (priority 2),” and the determination result for the “NW-B” changes from “20 Mbps (priority 2)” to “unlimited (weighted round robin (priority 5)).”

That is, switching is performed from information transmission mainly in the NW-A (QCI=131) and the NW-B to information transmission mainly in the NW-A (QCI=131) and the NW-A (QCI=130).

Specifically, the network usage mode determination unit 160 (or the information setting determination unit 170) notifies the network usage mode setting unit 180 of “using the NW-A (QCI=131) and NW-A (QCI=130)” which is a determination result, and the network usage mode setting unit 180 sets “using the NW-A (QCI=131) and the NW-A (QCI=130)” in the device.

In addition, similarly to Example 2-1, in a case where the bandwidth is insufficient, the device can use any one or more or all of the NW-A (QCI=9), the NW-C, and the NW-A (QCI=9) in accordance with its priority in addition to the NW-A (QCI=131) and the NW-A (QCI=130).

The content of a change in the network usage mode determination is an example. For example, in a case where the device is using only one line, a change may be made to switch from a best-effort line to a QoS-controlled priority line, or a change may be made to add a QoS-controlled priority line (change to use of multiple lines).

### Hardware Configuration Example

The control apparatus 100 described in the first embodiment and the second embodiment can be realized, for example, by causing a computer to execute a program describing the processing content described in the present embodiment. The computer may be a physical computer, or may be a virtual machine on a cloud.

That is, the control apparatus 100 can be realized by executing a program corresponding to processing that is performed by the device, using hardware resources such as a CPU and memory built into the computer. The program can be recorded on a computer-readable recording medium (a portable memory or the like) to be stored and distributed. In addition, the above-described program can also be provided through a network such as the Internet or e-mail.

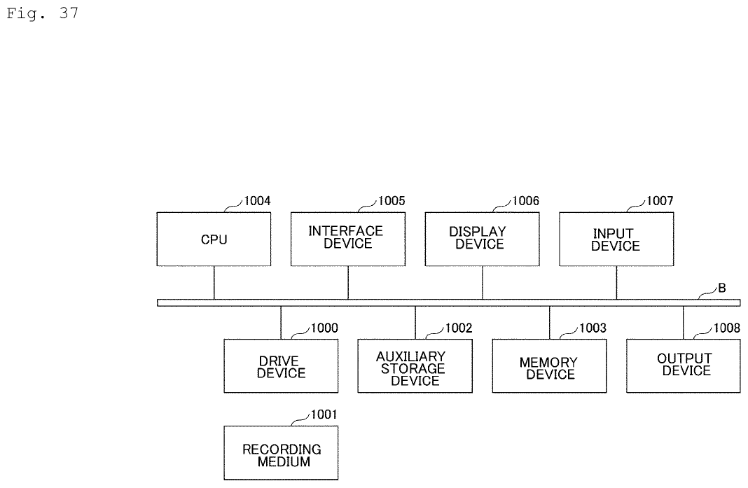

FIG. 37 is a diagram illustrating a hardware configuration example of the computer. The computer of FIG. 37 includes a drive device 1000, an auxiliary storage device 1002, a memory device 1003, a CPU 1004, an interface device 1005, a display device 1006, an input device 1007, an output device 1008, and the like which are connected to each other via a bus BS.

The program for realizing processing in the computer is provided by, for example, a recording medium 1001 such as a CD-ROM or a memory card. When the recording medium 1001 which stores the program is set in the drive device 1000, the program is installed in the auxiliary storage device 1002 from the recording medium 1001 via the drive device 1000. However, the program need not necessarily be installed from the recording medium 1001 and may be downloaded from another computer via a network. The auxiliary storage device 1002 stores the installed program and also stores necessary files, data, and the like.

The memory device 1003 reads and stores the program from the auxiliary storage device 1002 when an instruction to start the program is given. The CPU 1004 realizes functions related to the control apparatus 100 according to a program stored in the memory device 1003. The interface device 1005 is used as an interface for connecting to a network or the like. The display device 1006 displays a graphical user interface (GUI) or the like based on a program. The input device 1007 is composed of a keyboard, a mouse, buttons, a touch panel, and the like and is used for receiving, as inputs, input various operation instructions. The output device 1008 outputs a calculation result.

### Advantageous Effects of Embodiment

The technique according to the present embodiment makes it possible to proactively and reactively control an information transmission method. That is, it is possible to realize high accuracy of reactive control based on analysis of the current situation based on past history and high accuracy of proactive control based on future prediction based on past/present analysis and a schedule/plan.

### <Supplementary Note 1>

The following supplements are further disclosed as Supplementary note 1 in relation to the embodiments described above.

### (Supplement 1)

A control apparatus comprising:
a determination unit configured to determine a network usage mode of a device on the basis of a prediction value of quality related to transmission of information and requirements related to transmission of information; and
a setting unit configured to set the network usage mode determined by the determination unit in the device,
wherein the determination unit changes the network usage mode on the basis of a state of a network used by the device or a state of the device.

### (Supplement 2)

The control apparatus according to supplement 1, wherein the determination unit determines transmission quality of the information on the basis of a prediction value related to quality of the information and requirements related to the quality of the information, and
the setting unit sets the transmission quality determined by the determination unit in the device.

### (Supplement 3)

The control apparatus according to supplement 1 or 2, wherein the determination unit determines the network usage mode on the basis of information on future schedules that affect a network.

### (Supplement 4)

The control apparatus according to any one of supplements 1 to 3, wherein the network usage mode includes one or a plurality of networks used by the device, a level of priority is allocated to each network, and the determination unit decides a usage ratio of each network on the basis of the allocated level of priority.

### (Supplement 5)

The control apparatus according to supplement 4, wherein the determination unit varies a priority for each network on the basis of the state of the device.

### (Supplement 6)

The control apparatus according to any one of supplements 1 to 5, wherein the device is a moving object that travels,
the determination unit determines whether control related to the travel is performed on the device on the basis of a measurement value or a prediction value of the quality of the information after the network usage mode is changed, and
the setting unit performs the control related to the travel on the device in a case where the determination unit determines that the control related to the travel is performed.

### (Supplement 7)

The control apparatus according to any one of supplements 1 to 6, further comprising a position acquisition unit configured to acquire information on a position of the device as the state of the device.

### (Supplement 8)

A control method executed by a control apparatus, comprising:
a determination step of determining a network usage mode of a device on the basis of a prediction value of quality related to transmission of information and requirements related to transmission of information; and
a setting step of setting the network usage mode determined in the determination step in the device; and
a change step of changing the network usage mode on the basis of a state of a network used by the device or a state of the device.

### (Supplement 9)

A non-transitory storage medium having a program stored therein, the program causing a computer to function as each unit in the control apparatus according to any one of supplements 1 to 7.

### <Supplementary Note 2>

### (Supplement 1)

A control apparatus comprising:
a determination unit configured to determine a network usage mode of a device on the basis of a prediction value of network quality for each communication priority and requirements related to transmission of information; and
a setting unit configured to set the network usage mode determined by the determination unit in the device,
wherein the determination unit changes the network usage mode on the basis of a quality measurement result for each communication priority of a network used by the device.

### (Supplement 2)

The control apparatus according to supplement 1, wherein the determination unit determines transmission quality of the information on the basis of a prediction value related to quality of the information and requirements related to the quality of the information, and
the setting unit sets the transmission quality determined by the determination unit in the device.

### (Supplement 3)

The control apparatus according to supplement 1 wherein the determination unit determines the network usage mode on the basis of information on future schedules that affect a network.

### (Supplement 4)

The control apparatus according to supplement 1, wherein a level of priority is allocated to each network which is a target for determination of the network usage mode for each communication priority, and the determination unit decides a usage ratio for each communication priority of each network on the basis of the allocated level of priority.

### (Supplement 5)

The control apparatus according to supplement 1, wherein the device is a moving object that travels,
the determination unit determines whether control related to the travel is performed on the device on the basis of a measurement value or a prediction value of the quality of the information, and
the setting unit performs the control related to the travel on the device in a case where the determination unit determines that the control related to the travel is performed.

### (Supplement 6)

The control apparatus according to supplement 1, further comprising a position acquisition unit configured to acquire information on a position of the device.

### (Supplement 7)

A control method executed by a control apparatus, comprising:
a determination step of determining a network usage mode of a device on the basis of a prediction value of network quality for each communication priority and requirements related to transmission of information;
a setting step of setting the network usage mode determined in the determination step in the device; and
a change step of changing the network usage mode on the basis of a quality measurement result for each communication priority of a network used by the device.

### (Supplement 8)

A non-transitory storage medium having a program stored therein, the program causing a computer to function as each unit in the control apparatus according to any one of supplements 1 to 6.

Although the embodiment has been described above, the present invention is not limited to the specific embodiment, and various modifications and changes can be made within the scope of the gist of the present invention described in the claims.

This patent application claims its priority on the basis of International Patent Application No. PCT/JP2022/023862 filed on Jun. 14, 2022, and the entire content of International Patent Application No. PCT/JP2022/023862 is incorporated in the present application.

### REFERENCE SIGNS LIST

A Moving object
1A Communication unit
2A Automated driving unit
3A Camera
B Moving object control unit
10 Information transmission device
20 Information reception device
30 Information generation device
40 Information utilization device
100 Control apparatus
110 Network quality measurement unit
120 Information quality measurement unit
130 Network quality prediction unit
140 Information quality prediction unit
150 Storage unit
160 Network usage mode determination unit
170 Information setting determination unit
180 Network usage mode setting unit
190 Information setting unit
200 Schedule/plan DB
300 Past history/current situation DB
1000 Drive device
1001 Recording medium
1002 Auxiliary storage device
1003 Memory device
1004 CPU
1005 Interface device
1006 Display device
1007 Input device
1008 Output device

1. A control apparatus comprising:
a processor; and
a memory storing instructions that cause the processor to execute a process, the process including
determining a network usage mode of a device on the basis of a prediction value of network quality for each communication priority and requirements related to transmission of information; and
setting the network usage mode determined by the determining,
wherein the determining includes changing the network usage mode on the basis of a quality measurement result for each communication priority of a network used by the device.

2. The control apparatus according to claim 1,
wherein the determining includes determining transmission quality of the information on the basis of a prediction value related to quality of the information and requirements related to the quality of the information, and
the setting includes setting the transmission quality determined by the determining.

3. The control apparatus according to claim 1, wherein the determining includes determining the network usage mode on the basis of information on future schedules that affect a network.

4. The control apparatus according to claim 1, wherein a level of priority is allocated to each network which is a target for determination of the network usage mode for each communication priority, and a usage ratio is determined for each communication priority of each network on the basis of the allocated level of priority.

5. The control apparatus according to claim 1, wherein the device is a moving object that travels,
the determination unit determines the determining includes determining whether control related to the travel is performed on the device on the basis of a measurement value or a prediction value of the quality of the information, and
the setting unit performs the setting includes performing the control related to the travel on the device in response to the determining that the control related to the travel is performed.

6. The control apparatus according to claim 1, wherein the process further includes acquiring information on a position of the device.

7. A control method executed by a control apparatus, the control method comprising:
determining a network usage mode of a device on the basis of a prediction value of network quality for each communication priority and requirements related to transmission of information;
setting the network usage mode determined by the determining; and
changing the network usage mode on the basis of a quality measurement result for each communication priority of a network used by the device.

8. A non-transitory computer-readable recording medium having computer-readable instructions stored thereon, which when executed, cause a computer to function as the control apparatus according to claim 1.
